(19) United States
(12) Patent Application Publication
(10) Pub. No.: US 2022/0178645 A1
(43) Pub. Date: Jun. 9, 2022

(54) LAUNCH AND ACCELERATION SYSTEM AND METHOD

(71) Applicant: BILL WHISTLER KENWORTHY, ALGONQUIN, IL (US)

(72) Inventor: BILL WHISTLER KENWORTHY, ALGONQUIN, IL (US)

(21) Appl. No.: 17/485,494

(22) Filed: Sep. 26, 2021

Related U.S. Application Data
(60) Provisional application No. 63/083,899, filed on Sep. 26, 2020.

(51) Int. Cl. F41B 5/12

(52) U.S. Cl. CPC F41B 5/12; B25C 1/047

(57) ABSTRACT

An inventive system comprising a pistol crossbow, a blowgun, a first gas seal operatively associated with said blowgun, and a first pistol crossbow bolt selectively operatively associated with said pistol crossbow and said blowgun, said first pistol crossbow bolt configured to be capable of being selectively operatively interchanged between said pistol crossbow and said blowgun for elastic launching by said pistol crossbow and pneumatic launching by said blowgun. It may further be seen in view of this disclosure that within the scope and the spirit of the inventive disclosure and the claims appended hereunto are inventive system and method examples including, but not limited to, a method of driving a hardware fastener and/or providing a hardware fastener driving system, a system and method for a PPECS stabilizer acceleration interface, and a gas seal comprising a bulkhead and a label configured to be capable of being mounted to said bulkhead.

### CROSS-REFERENCE TO RELATED APPLICATIONS

This application claims the benefit of provisional patent application Ser. No. 63/083,899 filed 2020 Sep. 26 by the present inventor.

### FIELD OF THE INVENTION

Classification F41 B5/12 crossbows

### BACKGROUND OF THE INVENTION

Pistol crossbow bolts are generally small archery arrow projectiles launched from miniature crossbows commonly known as pistol crossbows. Typically, a pistol crossbow bolt has a metal head operationally coupled to an elongate shaft operationally coupled to a first vane. In certain examples, at least one metal, such as, for example, aluminum, may be employed in the composition of the shaft; in certain examples, the shaft may be composed at least in part of at least one nonmetallic material such as, for example, plastic resin, wood, and carbon fiber. The length of a pistol crossbow bolt may typically be in the range from about 4 inches to about 10 inches, and the mass of a pistol crossbow bolt may typically be in the range from about 50 grains to about 180 grains; however, certain pistol crossbow bolts may have masses and lengths that fall outside at least one of those ranges. For example, certain pistol crossbow bolts may have a mass of approximately 210 grains and a length of approximately 14 inches; certain other pistol crossbow bolts may have length and mass close to that of certain toothpicks, such as, for example, a mass of approximately 2 grains and a length of approximately 2 inches. Certain pistol crossbow bolts may be configured to have sufficient length such that at least a portion of the head extends beyond the forward end of the stock groove when the pistol crossbow bolt is loaded against the yoke; this may be advantageous when, for example, the pistol crossbow bolt is provided with a broadhead. Certain pistol crossbows have draw weights in the range from about 20 pounds to about 130 pounds; certain pistol crossbows may have draw weights that fall outside that range. For example, certain pistol crossbows may have a draw weight of approximately 150 pounds; on the other hand, certain pistol crossbows may have a draw weight of approximately 3 pounds and be configured to elastically launch a bolt having substantially the size and mass of a toothpick.

Elastic launching devices such as full-scale vertical bows, full-scale crossbows, pistol crossbows, and slingshots may be used to launch archery arrow projectiles; various embodiments of such archery arrow projectiles may vary widely in projectile length and projectile mass, according to launch platform and application. Examples from the archery arrow projectile length-mass spectrum include pistol crossbow bolts, full-scale crossbow arrows, and full-scale vertical bow arrows. Full-scale crossbows are generally not compatibly configured to launch pistol crossbow bolts, because the relatively low mass of the pistol crossbow bolt could cause a so-called “dry fire” condition in which the bow limbs and/or bowstring of the full-scale crossbow accelerate excessively fast, unduly increasing the risk of dry fire damage such as overstress, premature wear, structural damage, and even catastrophic failure. Full-scale crossbows typically are designed to shoot full-scale crossbow archery arrows that may range in length from about 16 inches to about 22 inches and range in mass from about 350 grains to 700 grains; certain examples may fall outside the length range, such as 12 inch full-scale crossbow bolts and 24 inch full-scale crossbow arrows, and certain examples may exceed the mass range, such as a 900 grain crossbow bolt intended for hunting dangerous game. The term bolt is often used interchangeably with the term arrow in speaking of crossbow projectiles, and the terms full-scale crossbow bolt and full-scale crossbow arrow are used interchangeably in this disclosure in reference to full-scale crossbow archery arrow projectiles. This disclosure also considers the terms pistol crossbow bolt and pistol crossbow arrow to be interchangeable, although this disclosure does not employ the term pistol crossbow arrow in the detailed descriptions of the inventive embodiment and method variants.

Full-scale longbows, full-scale recurve bows, full-scale lever bows, and full-scale compound bows are examples of full-scale vertical bows that generally lack the transverse stock found in a full-scale crossbow, although certain full-scale vertical bows and full-scale vertical bow accessories may provide certain features similar to those provided by the transverse stock coupled to the bow spring of a full-scale crossbow, such as an overdraw rest configured to provide an archery arrow projectile support point disposed in rearwardly spaced relation to the bow handle and/or riser of a full-scale vertical bow. Full-scale vertical bows are not necessarily oriented vertically during use, since full-scale vertical bows, especially longbows, may be held canted at an angle, and may even be held horizontally during use, but the designation of full-scale vertical bow helps provide a simple nomenclature to distinguish such bows from the generally horizontal alignment of a full-scale crossbow's bow spring during use; it may be noted that some full-scale crossbows provided with a transverse stock may include a bow prod that is intended to be aligned substantially vertically during use. Full-scale vertical bows typically use longer full-scale arrows than full-scale crossbows, although certain full-scale crossbow arrows may protrude beyond the forward end of the crossbow stock; full-scale vertical bows typically are designed to launch full-scale archery arrows that may range in length from about 27 inches to about 34 inches and range in mass from about 280 grains to about 700 grains; certain examples may exceed at least one of those ranges, such as an exemplary full-scale archery arrow designed for bowfishing and having a length of approximately 35 inches and a mass of approximately 1,500 grains. Full-scale archery arrows may also be launched by slingshots, which are often referred to as slingbows when so used.

Elastic archery projectors, such as full-scale vertical bows, full-scale crossbows, and pistol crossbows, may suffer dry fire damage if used with archery arrow projectiles having excessively light mass. Manufacturers may specify minimum projectile mass to use in a specific elastic archery projector in order to avoid undue risk of dry fire damage, and failure to follow the minimum projectile mass guidelines may result in voiding the manufacturer's warranty on the elastic archery projector. On the other hand, elastic archery projectors are generally able to safely launch archery arrow projectiles substantially more massive than the projectors' respective minimum projectile mass recommendations. For example, if a user cocks a certain full-scale crossbow and loads the crossbow with a 400 grain arrow, but then decides not to take the shot, one option for safely returning the crossbow to an uncocked state may be to use a decocking bolt that is exchanged for the loaded arrow before shooting the crossbow; decocking bolts may also known by names such as crossbow release arrows. A decocking bolt typically has a substantially blunt tip and may have a mass that is substantially heavier than arrows typically shot from the crossbow during hunting and/or target shooting. For example, a crossbow release arrow for a crossbow designed for use with crossbow bolts ranging in mass from about 350 grains to about 450 grains may have a mass within the exemplary range 500 grains to 1,100 grains. The extra mass of the decocking bolt slows down the acceleration and speed of the bolt, yoke, and bow prod, and may thereby actually reduce potential for damage to the crossbow.

U.S. Pat. No. 3,812,784 to Herter taught a one piece wad column and shot cup for a shotshell, wherein gas sealing cup 13 (element 13 according to the numbering system of U.S. Pat. No. 3,812,784) is coupled integrally to other portions of the one piece wad column and shot cup therein disclosed; the one piece wad and shot cup (element 10 according to the numbering system of U.S. Pat. No. 3,812,784) is designed to be positioned in a shotshell case so that the powder seal cup 13 overlies the powder charge in the shotshell; when the shotshell is fired by detonating the primer which ignites the powder charge, the sealing cup 13 is impelled forwardly under great force against the inertia of the shot charge confined in the cup and the closure of the shotshell. Thus, powder seal cup 13 (element 13 according to the numbering system of U.S. Pat. No. 3,812,784) serves by design as, and is exemplary of, an integral over-powder obturator in a shotgun shotshell fueled by dry chemical propellant.

U.S. Pat. No. 5,339,743 to Scarlata taught an ammunition system comprising a slug holding sabot and slug type shot shell, wherein gas seal wad 40 (element 40 according to the numbering system of U.S. Pat. No. 5,339,743) is nonintegral with sabot 10 and disk 42, and wherein wad 40, sabot 10, disk 42, and slug 24 are assembled together within shotgun shell 34 before being launched by expanding gas when shell 34 is fired, wherein shotgun shell 34 is provided with a chamber for propellant (elements 10, 24, 34, 40, and 42 according to the numbering system of U.S. Pat. No. 5,339,743). Thus, gas seal wad 40 (element 40 according to the numbering system of U.S. Pat. No. 5,339,743) serves by design as, and is exemplary of, a nonintegral over-powder obturator in a shotgun shotshell fueled by dry chemical propellant.

U.S. Pat. No. 4,625,706 to Turner taught an elastic powered compressed air gun including dart 120 with the rearwardly opening cup-shaped tail 122 of the dart 120 positioned in the rear extremity of the barrel 12; dart 120 is launched from barrel 12 by air compressed by elastic powered piston 44 within pneumatic cylinder 14 (elements 12, 14, 44, 120 and 122 according to the numbering system of U.S. Pat. No. 4,625,706). The cup-shaped tail 122 (element 122 according to the numbering system of U.S. Pat. No. 4,625,706) is exemplary of what the instant disclosure terms a PPECS stabilizer, wherein PPECS is an acronym for Protrusive Peg End, Conical Skirt; a PPECS stabilizer is provided with a substantially conical skirt defining a substantially circular rim defining an implied plane, wherein the conical skirt is coupled to a protrusive medial portion defining a substantially blunt peg end located in spaced relation to the said circular rim, and wherein the said medial portion intersecting the said implied plane defined by the said circular rim.

Hardware fasteners such as, for example, nails, screws, and staples may be used to fasten multiple construction workpieces together, including, for example, metal, wooden, and plastic workpieces. For example, certain screws may be used to secure drywall panel workpieces to lumber workpieces such as, for example, 2×4 wooden wall studs. Hardware fastener typically comprise a monolithic metal body defining an elongate shaft and a driving head. Screws are hardware fasteners provided with an inclined plane surface, such as one defined by helical threads, to assist in driving into workpieces. The driving head of a screw may be provided with one or more of a screw drive system configured to interface with one or more driver tools such as, for example, screwdrivers, hex keys, and nut drivers. The driving head of a nail is typically configured to interface with one or more driver tools such as, for example, hammers and nail guns.

Although certain commercially available archery arrow projectiles termed as pistol crossbow bolts may have masses exceeding 235 grains, in the following summary of the invention, brief description of the drawings of the inventive disclosure, and detailed description of the drawings of the inventive disclosure, as well as any appended claims, such archery arrow projectiles exceeding 235 grains are termed as, when used with a pistol crossbow, oversize bolt projectiles.

### SUMMARY OF THE INVENTION

The present disclosure is directed to providing an inventive system and method solution set with multiple applications, among which is a system comprising a pistol crossbow provided with a flexible yoke coupled to a bowed spring coupled to a stock, a blowgun provided with a hollow launch tube, a first gas seal configured to slidably interiorly partition the hollow launch tube of the blowgun, and a first pistol crossbow bolt provided with a first vane coupled to a shaft coupled to a metal head, wherein the first pistol crossbow bolt is configured to be selectively launched by the pistol crossbow and the blowgun. The first pistol crossbow bolt defines a proximal bolt end configured to selectively engage the flexible yoke and the gas seal. Thus, a shared ammo system is provided in which the blowgun and the crossbow may share the same ammunition: a first pistol crossbow bolt configured to be selectively elastically launched by the pistol crossbow and pneumatically launched by the blowgun and first gas seal.

The present disclosure is also directed to a method comprising the step of accelerating a first gas seal and a first pistol crossbow bolt within a hollow launch tube pneumatically pressurized by breath, wherein said first gas seal having a plastic resin bulkhead configured to operatively slidably interiorly partition said hollow launch tube, wherein said first pistol crossbow bolt having a mass within the range from 1 grain to 190 grains, inclusive, wherein said pistol crossbow bolt being configured to be selectively alternatively elastically accelerated by a cooperably configured pistol crossbow, wherein said first pistol crossbow bolt having a metal head coupled to a shaft defining a maximum shaft width, said shaft being coupled to a first vane defining a lateral edge and a trailing edge, said first vane extending laterally with respect to said shaft, said shaft terminating in a proximal end operatively engaged with said first gas seal.

As will be explained in further detail below, in certain method variants and embodiments, the first pistol crossbow bolt as provided may comprise a first vane having a first size-shape state that may be modified to a second size-shape state to cooperably configure the said first pistol crossbow bolt for acceleration within an operatively associated blowgun. Certain embodiments may comprise at least one segmented arrow projectile having multiple segments configured to couple together.

The present disclosure is also directed to a method for driving a hardware fastener, comprising the steps of providing a first hardware fastener comprising a monolithic metal body defining an elongate shaft and a driving head configured to engage a driver tool; providing a first gas seal comprising a bulkhead, said bulkhead comprising a plastic resin body designed to be suitable for use as a nonintegral overpowder obturator in a shotgun shotshell fueled by dry chemical propellant; providing a hollow acceleration tube reciprocally dimensioned for breath-driven acceleration of said first gas seal and said first hardware fastener therewithin; and pressurizing said hollow acceleration tube with breath to accelerate said first gas seal and said first hardware fastener therewithin toward said workpiece, wherein said first hardware fastener impacting said workpiece and driving at least partially into said workpiece. Alternatively, pneumatic pressure other than breath or in addition to breath may be used to accelerate the said first gas seal and the said first hardware fastener within the said hollow acceleration tube. In certain applications of the method, the said first gas seal may remain at least temporarily within the said hollow acceleration tube after impact of the said first hardware fastener against the said workpiece, and some portion of the said first hardware fastener may also remain at least temporarily within the said hollow acceleration tube after impact of the said first hardware fastener against the said workpiece. According to certain method variants and embodiments provided thereby, an element coupled to the said hollow acceleration tube, such as, for example, at least one of a stabilizer leg and a deflector shield, may touch the said workpiece when the said hollow acceleration tube is disposed in spaced relation to the said workpiece.

The present disclosure is also directed to a method of using a plastic resin body designed for use as a nonintegral overpowder obturator in a shotgun shotshell fueled by dry chemical propellant; the method may be described as a method of accelerating an elongate payload piece, comprising: a) providing a first gas seal comprising a bulkhead, said bulkhead comprising a monolithic plastic resin body designed to be suitable for use as a nonintegral overpowder obturator in a shotgun shotshell fueled by dry chemical propellant, wherein said first gas seal being provided with a lateral flange and a medial support column defining a forwardly opening annular groove therebetween; b) providing a hollow acceleration tube reciprocally dimensioned for breath-driven acceleration of said first gas seal therewithin; and c) providing an elongate payload piece configured for breath-driven acceleration within said hollow acceleration tube, wherein said first elongate payload piece defining a first substantially blunt end configured to be capable of being operatively disposed proximal said bulkhead and selectively aligned with at least one of said medial support column and said forwardly opening annular groove; wherein steps a, b, and c are in no particular order with respect to one another; certain variants of the method may optionally further include an additional step: d) pressurizing said hollow acceleration tube with breath to accelerate said first gas seal and said first payload piece therewithin, wherein said lateral flange slidably interiorly engaging said hollow acceleration tube during breath-driven acceleration, wherein said first substantially blunt end being operatively disposed proximal said bulkhead during breath-driven acceleration; wherein steps a, b, and c are in no particular order with respect to one another and wherein steps a, b, and c occur before step d.

The disclosure is also directed to a gas seal comprising a bulkhead and a label configured to mount to the bulkhead to provide enhanced visibility of the gas seal.

### BRIEF DESCRIPTION OF THE DRAWINGS OF THE INVENTIVE DISCLOSURE

FIGS. 1 through 32B depict a first embodiment and alternative embodiments of a system and related method, wherein the system comprising: a pistol crossbow comprising a flexible yoke, a deformable elastic thrust member operationally coupled to said flexible yoke, and a stock operationally coupled to said deformable elastic thrust member; a blowgun comprising a hollow launch tube defining an interior passage configured to be operatively pressurized by breath; a first gas seal operatively associated with said blowgun, said first gas seal comprising a bulkhead configured to be capable of operatively slidably substantially partitioning said interior passage when pressurized by breath therein, said bulkhead defining a maximum bulkhead width; and a first pistol crossbow bolt selectively operatively associated with said pistol crossbow and said blowgun, said first pistol crossbow bolt configured to be capable of being selectively operatively interchanged between said pistol crossbow and said blowgun for elastic launching by said pistol crossbow and pneumatic launching by said blowgun, said first pistol crossbow bolt comprising a metal head, a shaft operationally coupled to said metal head, said shaft defining a maximum shaft width less than said maximum bulkhead width, and a first vane operationally coupled to said shaft, wherein said first vane extending laterally with respect to said shaft, said first pistol crossbow bolt defining a proximal bolt end configured to be selectively operatively engaged with said flexible yoke and said first gas seal. Said first pistol crossbow bolt is configured to be capable of being selectively elastically launched by said pistol crossbow and pneumatically launched by said blowgun. In certain embodiments, the said first gas seal may be provided with a gas seal bulkhead comprising a monolithic plastic resin body designed to be suitable for use as a nonintegral over-powder obturator in a shotgun shotshell fueled by dry chemical propellant, wherein said monolithic plastic resin body may include a lateral flange and a medial support column defining an annular groove therebetween. According to certain system variants, method variants, and methods of use disclosed herein, said monolithic plastic resin body may be launched multiple times, even though said monolithic plastic resin body being designed to be suitable for substantially one-time disposable use in a shotgun shotshell fueled by dry chemical propellent. In certain embodiments, said first pistol crossbow bolt may have a mass within the range from 1 grain to 235 grains, inclusive. In certain embodiments, said first pistol crossbow bolt may have a mass within the range from 1 grain to 235 grains, inclusive, and a longitudinal length in the range from 0.5 inch to 18 inches, inclusive; in certain embodiments, said first pistol crossbow bolt may have a mass within the range 30 grains to 160 grains, inclusive, and a longitudinal length in the range 2 inches to 10 inches, inclusive; and in certain embodiments said pistol crossbow bolt may have a mass in the range 50 grains to 115 grains, inclusive, and a longitudinal length in the range 4 inches to 8 inches, inclusive. In certain embodiments that comprise a monolithic plastic resin body designed to be suitable for use as a nonintegral over-powder obturator in a shotgun shotshell fueled by dry chemical propellant, said monolithic plastic resin body may have a mass within the range from 1 grain to 12 grains, inclusive, and a longitudinal length within the range from 0.1 inch to 0.3 inch, inclusive; in certain alternative embodiments said monolithic plastic resin body may exceed 12 grains in mass, yet not exceed 32 grains in mass, and in certain alternative embodiments said monolithic plastic resin body may exceed 0.3 inch in length, yet not exceed 1.5 inches in length. Certain alternative embodiments of the first pistol crossbow bolt may exhibit values of mass and length outside at least one of the ranges given earlier, and certain alternative embodiments of the first pistol crossbow bolt may exhibit combinations of mass and length values different than those that appear in the ranges given above; for example, a first pistol crossbow bolt having a mass in the range 30 grains to 135 grains, inclusive, and a length in the range 10 inches to 12 inches, inclusive; another example is provided by a first pistol crossbow bolt having a mass in the range from 5 grains to 160 grains, inclusive, and a longitudinal length in the range from 0.5 inch to 16 inches, inclusive.

FIGS. 1 through 32B also depict a method comprising the steps of providing a pistol crossbow having a flexible yoke coupled to a deformable elastic thrust member coupled to a stock; providing a blowgun having a hollow launch tube defining an interior passage configured to be operatively pressurized by breath, providing a first gas seal having a bulkhead configured to be capable of slidably substantially partitioning said interior passage when said passage is pressurized by breath, wherein said bulkhead defining a maximum bulkhead width, and providing a first pistol crossbow bolt configured to be capable of being selectively operatively interchanged between said pistol crossbow and said blowgun for elastic launching by said pistol crossbow and pneumatic launching by said blowgun, wherein said pistol crossbow bolt having a metal head coupled to a shaft defining a maximum shaft width, said shaft being coupled to a first vane extending laterally with respect to said shaft, said shaft defining a proximal end configured to be capable of being selectively operatively engaged with said flexible yoke and said first gas seal, wherein said first pistol crossbow bolt having a mass within the range from 5 grains to 160 grains, inclusive, wherein the steps given thus far are in no particular order; the method may further include after the previously given steps a further step of selectively elastically launching said pistol crossbow bolt by said pistol crossbow and pneumatically launching said pistol crossbow bolt by said blowgun. According to a variant of the method just described, the step of providing a first gas seal is accomplished by providing a plastic resin body designed to be suitable for substantially disposable use as a nonintegral overpowder obturator in a shotgun shotshell fueled by dry chemical propellant; portions of FIGS. 33 through 37 show another variant of the method just described wherein the step of providing a first pistol crossbow bolt configured to be selectively operatively interchanged between said pistol crossbow and said blowgun is accomplished in part by reconfiguring said first vane from a first size-shape state to a second size-shape state.

FIGS. 33 through 37 depict exemplary embodiments and alternative embodiments for method, kit, and system application, wherein an exemplary embodiment of a kit comprising, in combination, a first pistol crossbow bolt configured to be capable of being elastically launched by a cooperably configured pistol crossbow, said pistol crossbow bolt comprising a metal head, a shaft operationally coupled to said metal head, said shaft defining a maximum shaft width, and a first vane operationally coupled to said shaft in laterally extending alignment with respect to said shaft, said first vane defining a trailing edge, said pistol crossbow bolt terminating proximally in a proximal bolt end, said pistol crossbow bolt having a mass in the range from 1 grain to 235 grains, inclusive, and a longitudinal length in the range from 0.5 inch to 18 inches, inclusive; and a first gas seal selectively operatively associated with said pistol crossbow bolt, said first gas seal comprising a bulkhead configured to be capable of slidably interiorly substantially partitioning a reciprocally dimensioned hollow launch tube of a blowgun during breath-driven acceleration therewithin, said bulkhead defining a maximum bulkhead width greater than said maximum shaft width, said first gas seal configured to operatively engage said proximal bolt end. FIGS. 34, 35, and 37 show embodiments of a processing tool that may in certain embodiments and methods of use be used to help reconfigure said first vane from a first size-shape state to a second size-shape state.

FIGS. 38 through 43 depict exemplary embodiments and alternative embodiments for method, kit, and system application, wherein an exemplary embodiment of a kit comprising, in combination: a first PPECS dart stabilizer, said PPECS dart stabilizer comprising a plastic resin stabilizer provided with a conical skirt defining a substantially circular rim defining an implied plane, said conical skirt coupled to a medial portion, said medial portion defining a substantially blunt peg end located in spaced relation to said circular rim, said medial portion rearwardly intersecting said implied plane defined by said circular rim; and a first gas seal selectively operatively associated with said PPECS dart stabilizer, said first gas seal comprising a bulkhead comprising a monolithic plastic resin body designed to be suitable for use as a nonintegral overpowder obturator in a shotgun shotshell fueled by dry chemical propellant, said bulkhead configured to be capable of slidably interiorly substantially partitioning a reciprocally dimensioned hollow launch tube of a blowgun during breath-driven acceleration therewithin, said first gas seal configured to operatively engage said peg end. The exemplary embodiments depicted in FIGS. 38 through 43 include an embodiment comprising, in combination, a first injection-molded PPECS dart stabilizer, said PPECS dart stabilizer provided with a conical skirt defining a substantially circular skirt rim defining an implied plane, said conical skirt coupled to a medial portion, said medial portion defining a substantially blunt peg end located in spaced relation to said substantially circular skirt rim, said medial portion intersecting said implied plane defined by said substantially circular skirt rim, wherein said substantially blunt peg end defining an axial peg end offset with respect to said substantially circular skirt rim; and a first gas seal bulkhead, said first gas seal bulkhead comprising a monolithic plastic resin body designed to be suitable for use as a nonintegral overpowder obturator in a shotgun shotshell fueled by dry chemical propellant, wherein said first gas seal bulkhead comprising a lateral flange and a medial support column defining an annular groove therebetween, wherein said lateral flange defining a forward flange rim and said medial support column defining a forward face defining an axial face offset with respect to said forward rim, wherein the said axial face offset defined by said forward face with respect to said forward rim does not exceed the said axial peg end offset defined by said substantially blunt peg end with respect to said substantially circular rim.

FIGS. 44 through 49 show a method for providing an accelerator for driving a first hardware fastener, comprising the steps of a) providing a first hardware fastener comprising providing a monolithic metal body defining an elongate shaft and a driving head; b) providing a first gas seal comprising a bulkhead, said bulkhead comprising a plastic resin body designed to be suitable for use as a nonintegral overpowder obturator in a shotgun shotshell fueled by dry chemical propellant; and c) providing a hollow acceleration tube reciprocally dimensioned for breath-driven acceleration of said first gas seal and said first hardware fastener therewithin, wherein steps a, b, and c are in no particular order relative each other; the method may include a further step d) of pressurizing said hollow acceleration tube with breath to accelerate said first gas seal and said first hardware fastener therewithin toward said workpiece, wherein said first hardware fastener impacting said workpiece and driving at least partially into said workpiece, wherein step d is after steps a, b, and c. In certain method variants, step d may further include touching said construction workpiece with a stabilizer leg coupled to said hollow acceleration tube, wherein said stabilizer leg assisting to stabilize said hollow acceleration tube in spaced relation to said workpiece during hardware fastener acceleration. FIGS. 44 through 59B also depict additional optional steps and method variants, and illustrate a system comprising, in combination, a payload piece accelerator comprising a hollow acceleration tube and a first gas seal operatively associated with said hollow acceleration tube, said hollow acceleration tube defining a curved interior face, said hollow acceleration tube configured to be capable of being pressurized by breath, said first gas seal comprising a plastic resin bulkhead, said bulkhead being provided with a lateral flange and a medial support column defining a forwardly opening annular groove therebetween, wherein said lateral flange configured to substantially circumferentially engage said curved interior face. The system may comprise further elements, such as a first hardware fastener comprising a monolithic metal body defining an elongate shaft coupled to a substantially blunt head configured to engage at least one driver tool cooperably configured to assist in driving said first hardware fastener at least partially into a workpiece. Certain alternative embodiments may comprise a leg coupled to the hollow acceleration tube, wherein the leg being configured to be capable of being selectively touchingly engaged with a surface of a workpiece such as a piece of lumber during acceleration of said first hardware fastener, and certain embodiments may include a shield for intercepting said first gas seal on at least one rebound trajectory after impact with at least one of said workpiece and said first hardware fastener when said first hardware fastener being at least partially driven into said workpiece.

FIGS. 60 through 63 depict exemplary embodiment and alternative embodiments of pneumatic containers that may be used to provide acceleration thrust according to certain embodiments and methods of use.

FIGS. 64 through 73 depict a comparison of several exemplary alternative embodiments of the first gas seal in terms of possible variations in the offset of the forward face of the central support column relative the forward rim of the lateral flange in certain first gas seal embodiments, as well as of possible variations in the offset of the rearward face of the central support column relative the rearward rim of the lateral flange. FIGS. 71, 72, and 73 compare the offset alignment of certain surfaces defined by an exemplary first gas seal to the offset alignment of certain surfaces defined by an exemplary PPECS dart stabilizer.

FIGS. 74-89 depict exemplary embodiments of a first gas seal comprising a bulkhead and a label configured to mount to the bulkhead, wherein the bulkhead being configured to slideably substantially interiorly partition a reciprocably dimensioned hollow tube. One exemplary embodiment comprises, in combination: a first gas seal bulkhead comprising a monolithic plastic resin body designed to be suitable for use as a nonintegral overpowder obturator in a shotgun shotshell fueled by dry chemical propellant, and a first label configured to be adhesively mountable to said bulkhead; there may also be certain embodiments of the apparatus wherein said first label is adhesively mounted to said first gas seal bulkhead. In certain embodiments, said first label comprises a base layer and an adhesive layer, said adhesive layer comprising a pressure-sensitive adhesive coating applied to said base layer.

FIG. 90 depicts an exemplary alternative embodiment of a crossbow suitable for use in the system depicted in FIGS. 1 through 32B, wherein the crossbow embodiment depicted in FIG. 90 is provided with a first pulley configured to serve as part of a compound pulley mechanism for providing mechanical advantage to a user bending the bow spring of the crossbow.

FIG. 91 depicts an exemplary alternative embodiment of a pistol crossbow bolt provided with multiple shaft segments that may be configured with an optional head to provide an archery arrow projectile in multiple length and mass configurations. FIGS. 92-95 depict an alternative embodiment wherein a first gas seal being tethered to a blowgun launch tube, as in FIG. 92, by a tether provided with an elongate, flexible tether cord; FIG. 93 depicts a first gas seal and a tether in relation to an implied embodiment variant hollow acceleration tube, and FIG. 94 depicts an embodiment in which a hollow acceleration tube being provided with a port. FIG. 95 shows an alternative embodiment of a first gas seal being further provided with an eyebolt for coupling with a tether.

### DETAILED DESCRIPTION OF THE DRAWINGS OF THE INVENTIVE DISCLOSURE

Throughout the disclosure, for convenience of discussion, numbering reflects certain alternate embodiments and optional features; element numbers may append at least one letter or number or both to indicate exemplary subvariant and alternative embodiments. For example, although no element in the present disclosure is numbered as 1, if there were an element 1, then 1a, 1b, and 1c could represent 3 exemplary subvariants or alternative element embodiments that may exemplify certain system and method subvariants. This convention is employed for convenience of discussion of exemplary options and is nonlimiting.

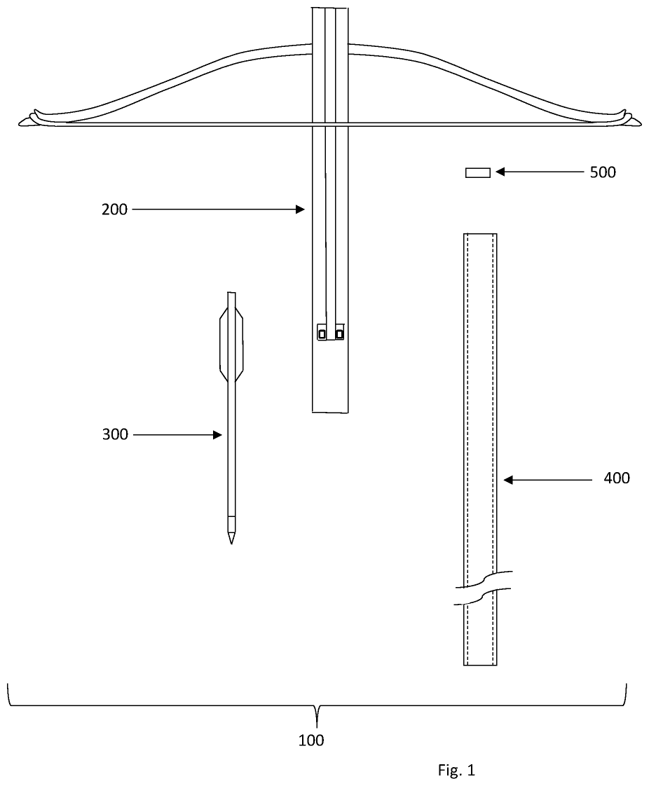

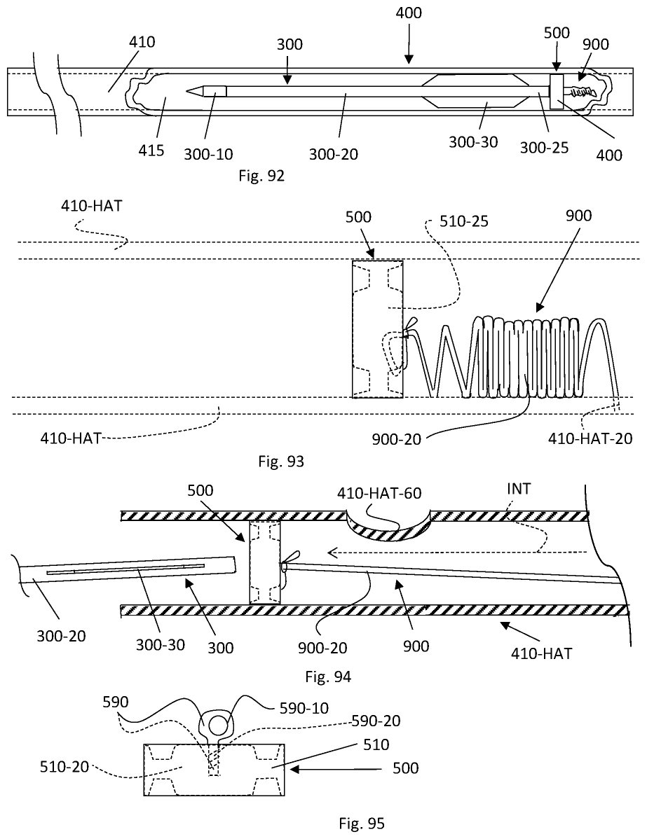

FIGS. 1 through 91 depict certain exemplary embodiments, methods of use, and method variants of the inventive system and method disclosure.

FIG. 1 shows an embodiment of launch system 100 comprising pistol crossbow 200, blowgun 400, first gas seal 500, and first pistol crossbow bolt 300.

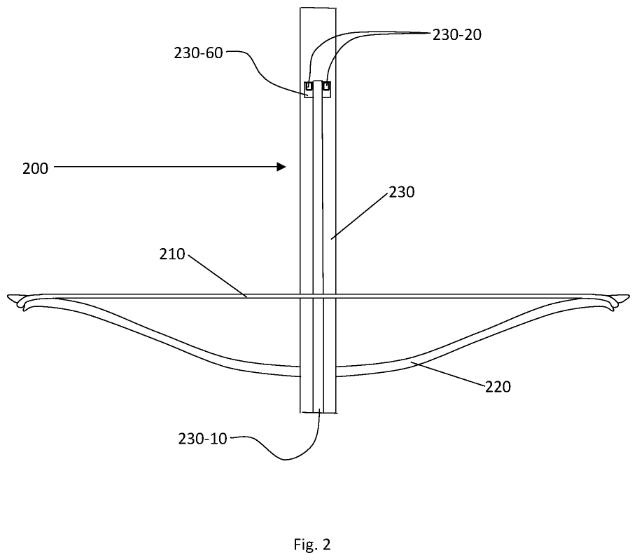

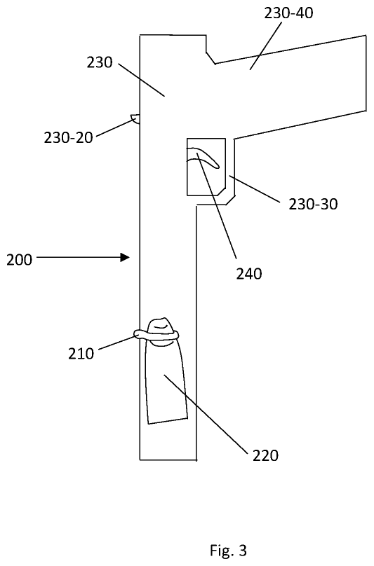

FIGS. 2 and 3 show, respectively, top and side views of pistol crossbow 400. Pistol crossbow 200 comprises flexible yoke 210, deformable elastic thrust member 220 operationally coupled to flexible yoke 210, and stock 230 operationally coupled to deformable elastic thrust member 220.

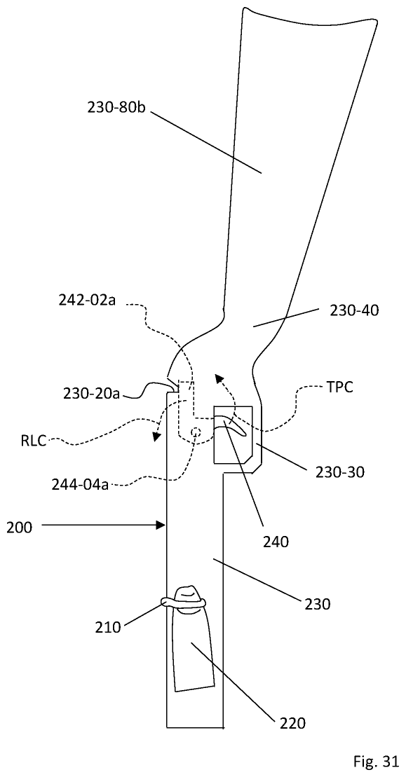

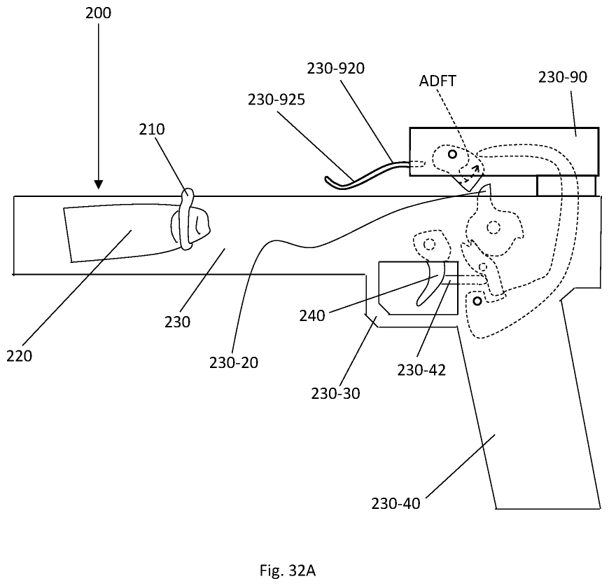

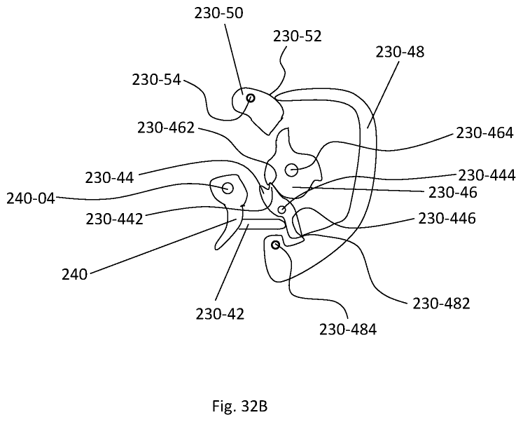

Pistol crossbow 200 may in certain embodiments include at least one optional feature, such as, for example, groove 230-10, string retainer 230-20, string retainer receiving recess 230-60, trigger 240, trigger guard 230-30, and handle 230-40; such optional features may be coupled to stock 230 and may in certain embodiments be formed as one or more integral portions of stock 230. In certain embodiments, string retainer 230-20 may be fixed with respect to stock 230. In other embodiments, string retainer 230-20 may be displaceably coupled to stock 230; for example, string retainer 230-20 may be rotatably coupled to stock 230 and may in addition be designed to be capable of rotating down into string retainer receiving recess 230-60 to provide clearance for passage therepast of yoke 210. FIGS. 31 and 32 show exemplary embodiments with additional details of optional feature 230-20 and other optional features.

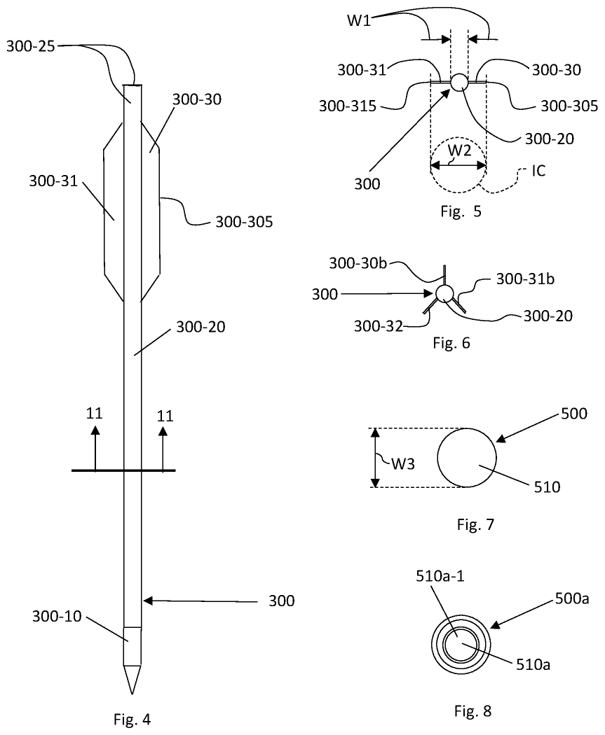

FIGS. 4 through 8 depict first pistol crossbow bolt 300 and first gas seal 500. First pistol crossbow bolt 300 is selectively operatively associated with pistol crossbow 300 and blowgun 400, and first gas seal 500 is associated with blowgun 400. First pistol crossbow bolt 300 is configured to be capable of being selectively operatively interchanged between pistol crossbow 200 and blowgun 400 for elastic launching by pistol crossbow 200 and pneumatic launching by blowgun 400. First pistol crossbow bolt 300 comprises metal head 300-10, shaft 300-20 coupled to metal head 300-10, and first vane 300-30 coupled to shaft 300-20, said first vane 300-30 extending laterally with respect to shaft 300-20. First pistol crossbow bolt 300 defines proximal bolt end 300-25 configured to be selectively operatively engaged with flexible yoke 210 and first gas seal 500. Certain alternative embodiments of first pistol crossbow bolt 300 may in lieu of metal head 300-10 comprise a head composed at least in part of plastic resin; certain embodiments of first pistol crossbow bolt 300 may be provided with threads for removably coupling bolt heads such as metal heads and plastic heads, which may permit interchangeably coupling different heads with shaft 300-20; such heads may include, but not be limited to, at least one of exemplary heads such as practice heads, target points, field points, broad heads, fishing barbs, and blunts, and any of such exemplary head types may also be provided as a substantially fixed, rather than interchangeable, substitute for basic metal head 300-10 comprised within first pistol crossbow bolt 300. In certain embodiments, head 300-10 may be provided along with a second head having a different configuration from head 300-10, such as with a different width and/or a different mass, wherein head 300-10 and the second head may be selectively interchanged to optimize performance according to which one of pistol crossbow 200 and blowgun 400 is being selectively used to launch first pistol crossbow bolt 300; in certain embodiments replacing head 300-10 with a second head may convert first pistol crossbow bolt 300 into an oversize bolt projectile having a mass exceeding 235 grains. Certain alternative embodiments of first pistol crossbow bolt 300 may be supplied without metal head 300-10 and without any other head, permitting the user to independently selectively supply at least one head configured to couple with shaft 300-20 directly and/or via an intermediary coupling device such as, for example, at least one of a threaded insert and a threaded outsert.

First pistol crossbow bolt 300 is configured to be capable of being selectively elastically launched by pistol crossbow 200 and pneumatically launched by blowgun 400. Shaft 300-20 defines maximum shaft width W1, as shown in FIG. 5. FIG. 5 shows a view along section line 11 from FIG. 4. The embodiment depicted in FIGS. 4 and 5 includes first vane 300-30 and second vane 300-31. First vane 300-30 and second vane 300-31 respectively define lateral edge 300-305 and lateral edge 300-315, wherein lateral edges 300-305 and 300-315 conjointly defining maximum vane span W2. Maximum vane span W2 may also be considered to be the diameter of implied circle IC passing through lateral edges defined by a plurality of vanes, an approach which may be useful in measuring maximum vane span W2 for an alternate embodiment such as the one shown in FIG. 6 in which the three vanes are configured such that that no two of the vanes are spaced 180 degrees apart. FIG. 6 shows an alternate vane configuration comprising first vane 300-30b, second vane 300-31b, and third vane 300-32b. Shaft 300-20 and first vane 300-30 shown in FIGS. 4 through 6 may in certain embodiments be defined by a monolithic member, and in certain such embodiments first vane 300-30 may be substantially rigid, yet in certain such embodiments first vane 300-30 may additionally or alternatively be resiliently flexible. In certain alternative embodiments, shaft 300-20 may be nonintegral with first vane 300-30; in certain such alternative embodiments first vane 300-30 may be affixed to shaft 300-20 by a suitable adhesive. First vane 300-30 is depicted as extending laterally from shaft 300-20 in substantially radial alignment with shaft 300-20; in certain alternative embodiments, first vane 300-30 may have a different type of alignment with shaft 300-20, such as, for example, a substantially tangential alignment. In certain embodiments, first vane 300-30 may be substantially rigid. In certain embodiments, first vane 300-30 may be somewhat flexible; in certain such embodiments first vane 300-30 may be resiliently flexible, and in certain such embodiments first vane 300-30 may be somewhat limply flexible. First vane 300-30 may be composed of at least one of exemplary materials including, but not limited to, plastic resin, wood, metal, feathers, and carbon.

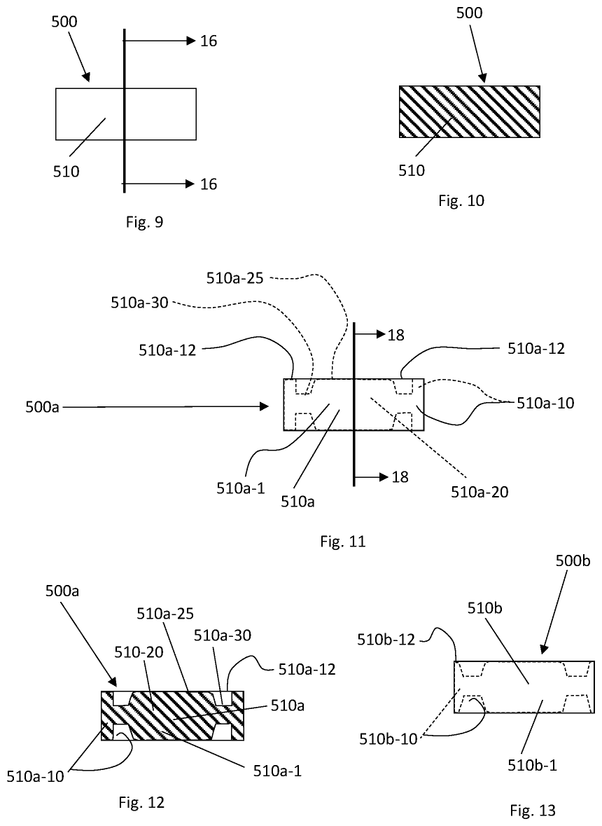

FIGS. 7 through 16 show first gas seal 500 associated with blowgun 400. FIGS. 7, 9, and 10 show an exemplary embodiment of first gas seal 500. FIGS. 7 and 9 are respectively front and side views of first gas seal 500, and FIG. 10 is a sectional view along section line 16 in FIG. 9. First gas seal 500 comprises bulkhead 510. First pistol crossbow bolt's shaft 300-20 defines maximum shaft width W1 and gas seal bulkhead 510 defines maximum bulkhead width W3, wherein maximum shaft width W1 is less than maximum bulkhead width W3. FIGS. 8 and 11 through 16 show alternate embodiments of first gas seal 500. The description will return to first gas seal 500 after describing blowgun 400.

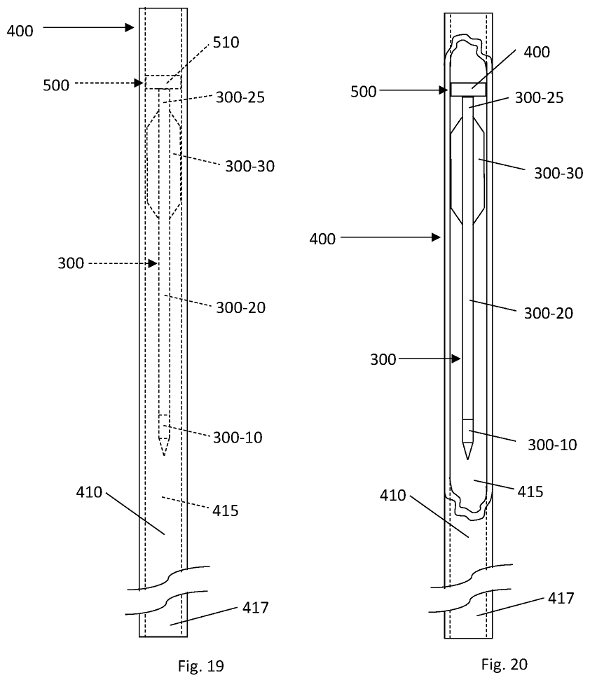

Blowgun 400 comprises hollow launch tube 410 defining interior passage 415 configured to be operatively pressurized by breath. As shown in FIGS. 19, 21, and 22, first gas seal 500 includes bulkhead 510 configured to slidably substantially partition interior passage 415 when passage 415 is pressurized by breath. Proximal bolt end 300-25 is shown engaging first gas seal 500. Hollow launch tube 410 is shown broken at the distal end to permit scaling the drawing as shown; the total length of hollow launch tube 410 may vary according to embodiment. In certain embodiments, the length of hollow launch tube 410 may be substantially fixed. In other embodiments, hollow launch tube 410 may comprise a plurality of sections that can be coupled to provide a functional launch tube unit 410; in some such embodiments, varying the number of sections coupled together may vary the total length of the assembled launch tube unit 410, and according to certain methods of use one section may be used by itself to provide a monolithic launch tube unit 410. Generally speaking, whether hollow launch tube 410 is monolithic or sectional, the total length of hollow launch tube 410 when in functional use may typically be in a range from 2 feet to 6 feet, inclusive, and a useful balance of power and maneuverability may be achieved for many users by hollow launch tube 410 having length within the range from 3 to 5 feet, inclusive; however, longer and shorter lengths may also be used. For example, certain embodiments of hollow launch tube 410 may have length within the range from 6 feet to 9 feet, and certain embodiments of hollow launch tube 410 may have length within the range from 1 inch to 2 feet.

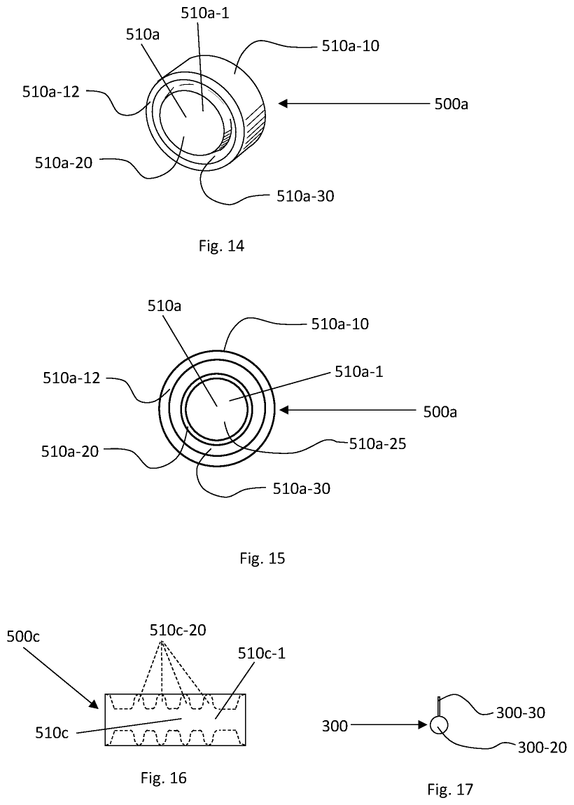

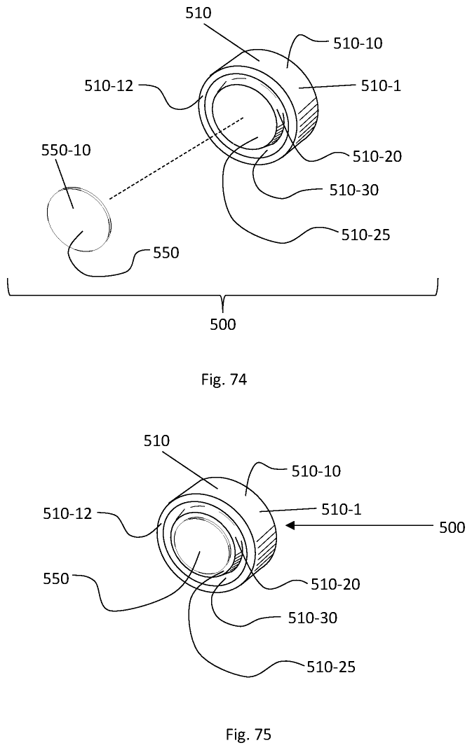

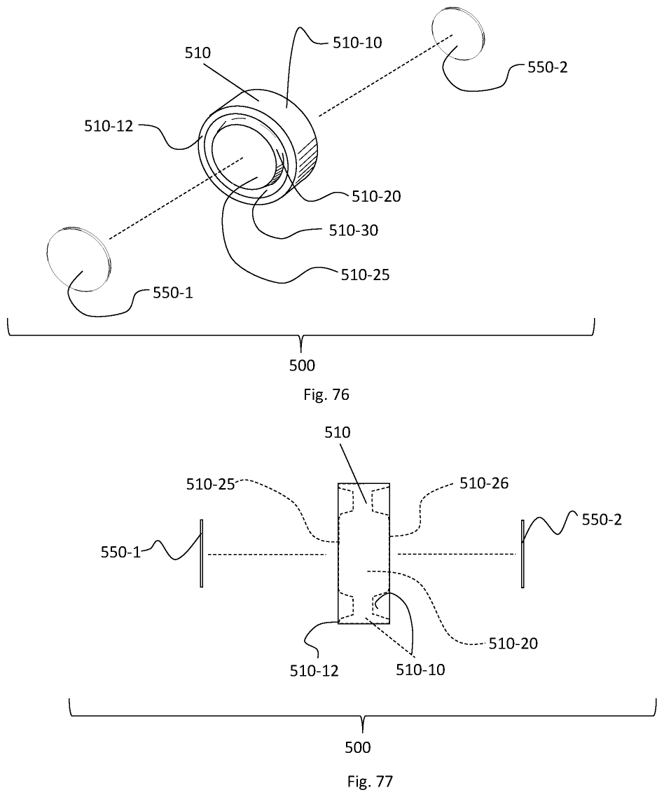

Returning to first gas seal 500, in certain embodiments, first gas seal 500 may comprise a monolithic plastic resin body designed for use as a nonintegral over-powder obturator in a shotgun shotshell fueled by dry chemical propellant. FIGS. 8, 11, 12, and 14 through 16 show first gas seal embodiment 500a in which bulkhead 510a comprises monolithic plastic resin body 510a-1 designed for disposable use as a nonintegral over-powder obturator in a shotgun shotshell fueled by dry chemical propellant, wherein plastic resin body 510a-1 includes lateral flange 510a-10 and medial support column 510a-20 defining annular groove 510a-30 therebetween. The dimensions of plastic resin body 510a-1 shown in FIGS. 8, 11, 12, and 14 through 16 are exemplary and nonlimiting. An exemplary, non-limiting embodiment of plastic resin body 510a-1 may have length within the range from 0.18 inch to 0.26 inch, inclusive, and width within the range from 0.615 inch to 0.64 inch, inclusive, with a mass in the range from 5 grains to 10 grains, inclusive; another exemplary, non-limiting embodiment of plastic resin body 510a-1 may have length within the range from 0.24 inch to 0.27 inch, inclusive, and width within the range from 0.645 inch to 0.66 inch, inclusive, with a mass in the range from 7 grains to 14 grains, inclusive. Another exemplary, non-limiting embodiment of plastic resin body 510a-1 may have length within the range from 0.15 inch to 0.25 inch, inclusive, and width within the range from 0.375 inch to 0.425 inch, inclusive, with a mass in the range from 1.5 grains to 4 grains, inclusive. An exemplary, non-limiting embodiment of hollow launch tube 410 defining an interior passage configured to be operatively pressurized by breath, wherein said interior passage has an inner diameter within the range from 0.62 inch to 0.625 inch, inclusive, may be cooperably configured for breath-powered acceleration therewithin of an exemplary, non-limiting plastic resin body 510a-1 having a length of substantially 0.247 inch and a width of substantially 0.618 inch; for example, each of three exemplary embodiments of hollow launch tube 410 respectively having specific interior diameters of 0.62 inch, 0.622 inch, and 0.625 inch may be selectively substantially interiorly partitioned by the same exemplary plastic resin body 510a-1 having a length of substantially 0.247 inch and a width of substantially 0.618 inch, thereby enabling certain system embodiments which may include first gas seal 500 cooperably configured for breath-driven acceleration within at least two different hollow launch tubes (410) having different inner diameters, although certain such system embodiments may comprise a single hollow launch tube 410 having only one inner diameter from among a continuous range and/or discrete set of cooperable inner diameter options. FIG. 11 is a side view of first gas seal 500a and FIG. 12 is a sectional view along section line 18 from FIG. 11. Support column face 510a-25 may be substantially flat; in certain embodiments face 510a-25 may alternatively be somewhat plano-concave; in certain embodiments face 510a-25 may be somewhat plano-convex. In the embodiment shown in FIGS. 8 and 11 through 16, face 510a-25 is substantially coplanar with rim 510a-12; in certain embodiments face 510a-25 may be somewhat axially offset from rim 510a-12, as shown in FIGS. 66 through 73. FIG. 13 shows alternative first gas seal embodiment 500b comprising bulkhead 510b. Bulkhead 510b comprises plastic resin obturator body 510b-1, wherein plastic resin body 510b-1 being designed for use as a nonintegral overpowder obturator in a shotgun shotshell fueled by dry chemical propellant. Plastic resin body 510b-1 includes flange 510b-10 defining forward flange rim 510b-12, wherein forward flange rim 510b-12 being narrower than forward flange rim 510a-12 defined by embodiment 500a shown in FIGS. 11 and 12, and the inner wall of flange 510b-10 slants at an angle; in certain embodiments, slanted slopes of wall surfaces may be designed to allow easier release of plastic resin body 510b-1 from a mold during an injection molding process. In certain embodiments, slopes of wall surfaces may be designed to encourage and control obturation characteristics for the designed use of plastic resin body 510b-1 in a shotshell fueled by dry chemical propellant. FIG. 14 is a perspective view of first gas seal 500a, and FIG. 15 is an enlarged view of the front view of first gas seal 500a shown in FIG. 8. FIG. 16 shows a side view of alternate embodiment 500c comprising bulkhead 510c, wherein bulkhead 510c comprising plastic resin body 510c-1 wherein plastic resin body 510c-1 defining medial support column 510c-20 comprising a plurality of concentric rings. Throughout the drawings, in certain figures depicting first gas seal embodiments having annular grooves and/or concentric rings, side views that show internal features with dashed lines generally show the profile view of internal features as if hemisected so that only the maximum outer and inner diameters of the groove/ring are shown, in order to avoid confusion of overlapping details. In certain embodiments, first gas seal 500 may essentially consist of monolithic plastic resin body 510-1 designed for substantially one-time use as a nonintegral over-powder obturator in a shotgun shotshell fueled by dry chemical propellant; in certain embodiments, first gas seal 500 consists of monolithic plastic resin body 510-1 designed to be suitable for use as a nonintegral over-powder obturator in a shotgun shotshell fueled by dry chemical propellant. According to certain methods and embodiments disclosed in the instant disclosure, first monolithic plastic resin body 510-1 may generally be used multiple times. Alternatively, in certain embodiments first gas seal 500 comprises bulkhead 510, wherein bulkhead 510 may comprise a first monolithic plastic resin body 510-1, such as exemplary variants 510a-1, 510b-1, and 510c-1 described above, wherein said first monolithic plastic resin body 510-1 is designed for use as a nonintegral over-powder obturator in a shotgun shotshell fueled by dry chemical propellant, and in certain such embodiments first gas seal 500 may comprise monolithic plastic resin body 510-1 and at least one additional component, an example of which may be found in FIGS. 74 and 75 depicting first gas seal 500 comprising monolithic plastic resin body 510-1 and label 550 configured to be mountable to monolithic plastic resin body 510-1.

FIG. 17 shows alternative first pistol crossbow bolt embodiment 300b in which first vane 300b-30 is the only vane. For certain embodiments of first pistol crossbow bolt 300 with certain vane configurations, such as those shown in FIGS. 6 and 17, it may be useful to provide crossbow stock 230 with groove 230-10 having sufficient depth to accommodate first vane 300-30.

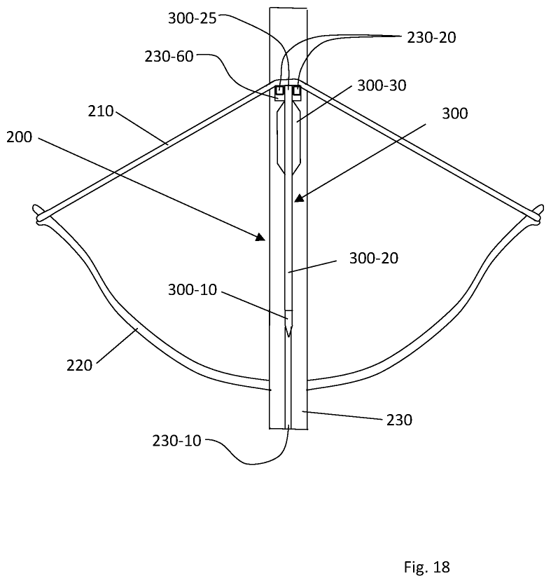

FIG. 18 is a top view of pistol crossbow 200 in cocked position with first pistol crossbow bolt 300 engaged in loaded position against stock 230 with shaft 300-20 resting in groove 230-10 and bolt end 300-25 engaged against flexible yoke 210, with elastic thrust member 220 bent to permit flexible yoke 210 to be restrainingly engaged by yoke retainer 230-20 to hold elastic thrust member 220 in bent posture.

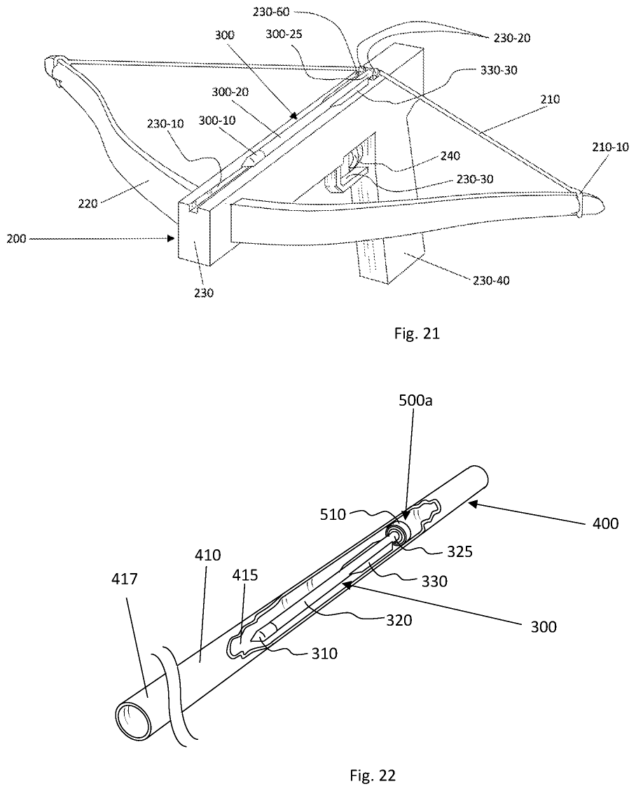

FIGS. 19 and 20 are top views of blowgun 400 with first gas seal 500 and first pistol crossbow bolt 300 disposed within passageway 415 defined by hollow launch tube 410. In FIG. 20 a portion of hollow launch tube 410 is shown cut away in order to provide a direct view of passageway 415, first gas seal 500, and first pistol crossbow bolt 300. In FIGS. 19 and 20 hollow launch tube 410 is shown broken to allow distal end 417 of hollow launch tube 410 to be shown in the drawing. In certain embodiments, the longitudinal length of hollow launch tube 410 may be within the range from 2 feet to 6 feet, inclusive; however, in certain embodiments the longitudinal length of hollow launch tube 410 may be outside the range from 2 feet to 6 feet, inclusive. In some embodiments, hollow launch tube 410 may be sectional, with a plurality of sections that the user may selectively configure to provide multiple launch tube lengths; a launch tube section may be used singly or alternatively may be coupled with at least one other launch tube section to selectively provide multiple length configurations. Although numbered as element 500 in FIGS. 19 and 20, first gas seal 500 may also generally refer to alternative embodiments such as, but not limited to, first gas seal embodiments 500a, 500b, and 500c. FIGS. 21 and 22 are perspective views showing first pistol crossbow bolt 300 selectively interchanged between pistol crossbow 200 (FIG. 21) and blowgun 400 (FIG. 22) for elastic launching by pistol crossbow 200 and pneumatic launching by blowgun 400. Although numbered as element 500a in FIGS. 21 and 22, first gas seal 500a may be considered representative of certain alternative embodiments that may also be suitable for use, such as, but not limited to, first gas seal embodiments 500, 500b, and 500c.

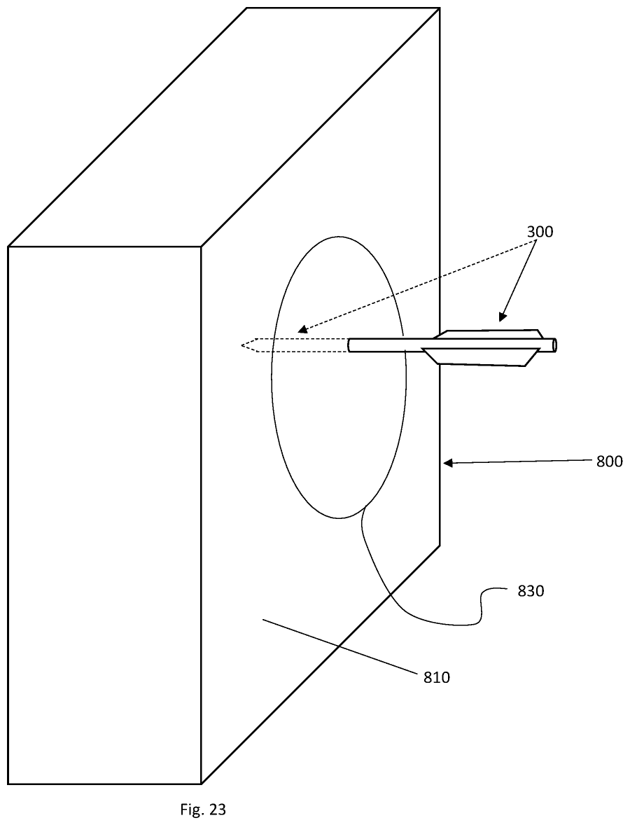

FIG. 23 is a perspective view of first pistol crossbow bolt 300 captured in target 800. Certain launch system 100 embodiments and methods of use may enable a user to selectively use pistol crossbow 200 and blowgun 400 to launch first pistol crossbow bolt 300 at common target 800 wherein target 800 being compatible for use with both and either of the projectile launchers to capture bolt 300. Certain embodiments of target 800 may be configured to be suitable for penetratedly receiving, frictionally engaging, and releasably capturing first pistol crossbow bolt 300 when first pistol crossbow bolt 300 is selectively launched by said pistol crossbow and said blowgun. Target 800 may comprise target boss 810 configured to releasably capture bolt 300. Target boss 810 may comprise at least one layer of polymer foam suitable for penetratedly receiving, frictionally engaging, and capturing first pistol crossbow bolt 300 when first pistol crossbow bolt 300 is selectively launched by crossbow 200 and blowgun 400. Target 800 may additionally or alternatively comprise at least one layer of plastic sheeting. The embodiment shown in FIG. 23 includes optional target pattern 830 printed on the forward face of target 800. In certain embodiments a portion of target 800 that is typically subjected most frequently to hits and accrual of damage from bolts, such as, for example, the central area demarcated by pattern 830, may be configured to be capable of being selectively removed and replaced. Target 800 is depicted in FIG. 23 as being substantially formed as a right rectangular prism; certain alternative embodiments may have other shapes, wherein examples include, but are not limited to, cubes, spheres, and pyramids. Target 800 may additionally or alternatively comprise a bag configured to hold material suitable for stopping and capturing first pistol crossbow bolt 300.

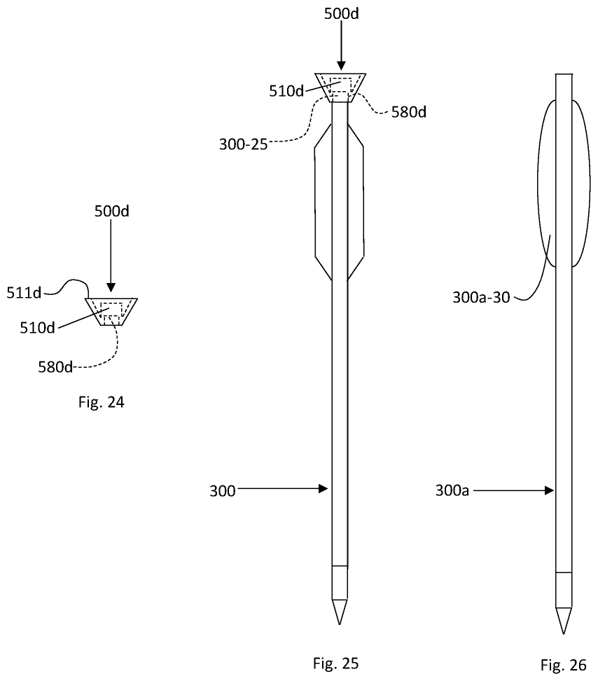

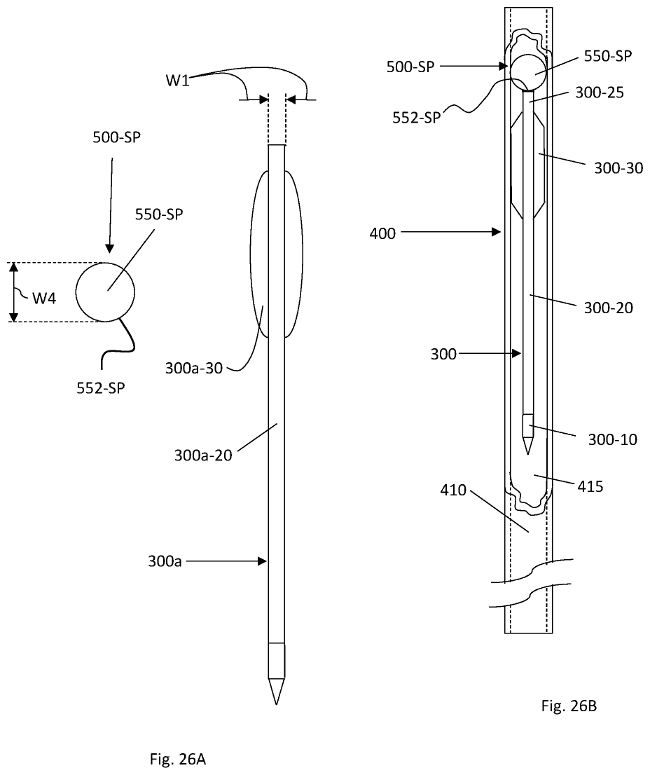

FIGS. 24 and 25 show alternative first gas seal embodiment 500d wherein bulkhead 510d is provided with socket 580d configured to be capable of receiving and frictionally engaging bolt end 300-25 with sufficient firmness to remain attached during launch and flight of pistol crossbow bolt 300 to a target such as, for example, target 800. Such an embodiment of gas seal 500d may, as shown in FIGS. 24 and 26, include conical skirt 511d. FIG. 25 shows gas seal 500d mounted to first pistol crossbow bolt 300 with bolt end 300-25 inserted within socket 580d and gas seal 500d thereby frictionally attached to first pistol crossbow bolt 300 with sufficient firmness to remain attached during launch and flight to target. Socket 580d may selectively be frictionally attached to and removed from first pistol crossbow bolt 300, and flexible yoke 210 may be engaged directly with bolt end 300-25 when gas seal 500d is removed from bolt 300. Alternatively, according to certain methods of use, adhesive may be used to make the connection between socket 580d and bolt end 300-25 substantially permanent.

FIG. 26 shows an alternative embodiment of first pistol crossbow bolt 300a provided with first vane 300a-30 wherein first vane 300a-30 has a different shape than first vane 300-30 shown in FIG. 4 and certain other preceding figures. The shape of first vane 300a-30 in FIG. 26 is an example of a type of shape sometimes referred to as parabolic in archery terminology, although the term may be suggestive of approximate parabolic shape rather than necessarily indicating exact conformity to a mathematical quadratic curve. It will further be understood that use of other mathematical terms, such as conical, do not necessarily indicate geometrically perfect shapes and forms, and that practical limits that apply to manufacturing processes and material properties may place practical limits upon sizes and shapes of components described herein. Geometric ideals may be approximated to desired precision within practical limits of material properties, manufacturing processes, and field use conditions such as temperature and wear and tear. It will be apparent in light of this disclosure to one skilled in the art that the size-shape configuration of first vane 300-30 may be different than the size-shape configuration of the exemplary, illustrative embodiments shown in the instant disclosure. In certain embodiments, first pistol crossbow bolt 300 may define maximum vane span W2 within the range from 0.4 inch to 0.68 inch inclusive. In certain embodiments, first pistol crossbow bolt 300 may define maximum vane span W2 within the range from 0.55 inch to 0.6 inch inclusive. In certain embodiments, first pistol crossbow bolt 300 may define maximum vane span W2 less than 0.4 inch or greater than 0.68 inch, within practical limits of material properties, manufacturing processes, and field use conditions, noting that zero, negative, and infinite vane span values are not within practical limits of material properties. For example, in certain embodiments, first pistol crossbow bolt 300 may define maximum vane span W2 within the range from about 0.3 inch to about 0.7 inch. As mentioned earlier, maximum vane span W2 may be defined by the diameter of an implied circle passing through the lateral edges of plural vanes. Maximum vane span W2 may typically be the maximum transverse width defined by first pistol crossbow bolt 300; certain alternative embodiments of first pistol crossbow bolt may comprise a broadhead provided with a first blade, wherein the broadhead may in certain such embodiments define the maximum transverse width of first pistol crossbow bolt 300.

FIG. 26A shows first pistol crossbow bolt embodiment 300a with alternative first gas seal embodiment 500-SP. Alternative first gas seal embodiment 500-SP is provided with substantially spherical body 550-SP. Spherical body 550-SP defines width W4 greater than width W1 defined by shaft 300a-20 of first pistol crossbow bolt embodiment 300a. FIG. 26B shows a top view of blowgun 400 with first gas seal embodiment 500-SP and first pistol crossbow bolt 300 disposed within passageway 415 defined by hollow launch tube 410; first pistol crossbow bolt embodiment 300a could similarly be disposed within passageway 415. In FIG. 26B a portion of hollow launch tube 410 is shown cut away in order to provide a direct view of passageway 415, first gas seal alternative embodiment 550 provided with spherical body 550-SP defining curved surface 552-SP, and first pistol crossbow bolt 300, wherein first vane 300-30 may cooperatingly engage with passageway 415 to help hold proximal bolt end 300-25 substantially aligned with the middle portion of the curved surface 552-SP of spherical body 550-SP for stable engagement thereagainst during launch. In FIG. 26B hollow launch tube 410 is shown broken to allow distal end 417 of hollow launch tube 410 to be shown in the drawing. Spherical body 550-SP is advantageously lightweight with good impact resistance. Spherical body 550-SP may be composed at least in part of one or more plastic resins such as, for example, polyvinyl chloride; wood and synthetic polymers such as polyamides and polyacrylates are other nonlimiting examples of candidates contemplated for providing spherical body 550-SP. It is also contemplated that at least one of certain substantially nonfrangible injection-molded plastic spheres suitable for launch from paintball markers may be used to provide an embodiment of spherical body 550-SP for use in one or more embodiments of hollow launch tube 410 defining passageway 415 cooperatingly sized and shaped for passage therethrough of such an embodiment of spherical body 550-SP. Certain embodiments of spherical body 550-SP may be solid; certain embodiments of spherical body 550-SP may define at least one interior void, such as a hollow airspace.

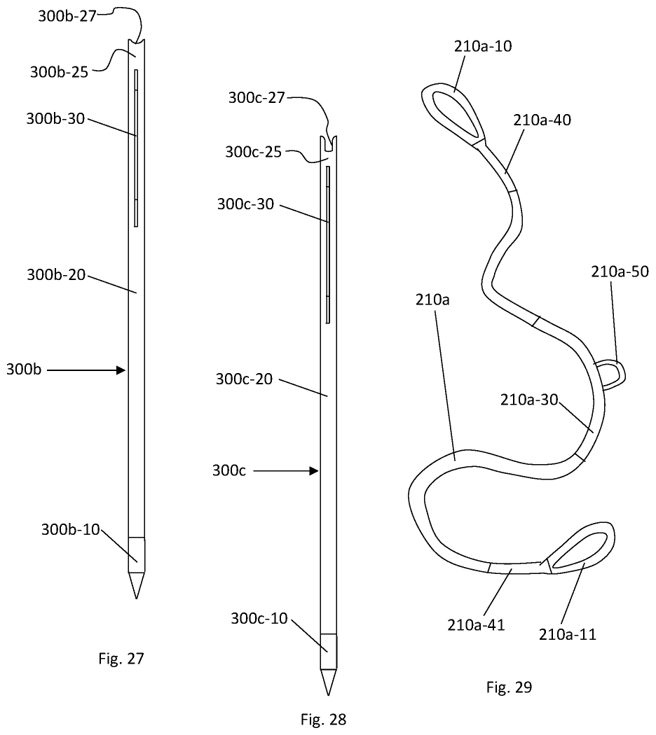

FIG. 27 shows exemplary alternative embodiment first pistol crossbow bolt 300b provided with moon nock 300b-27 configured to engage flexible yoke 210. FIG. 28 shows exemplary alternative first pistol crossbow bolt embodiment 300c provided with substantially parallel-sided nock 300c-27 defined by bolt end 300c-25.

In certain alternative embodiments, flexible yoke 210 may comprise at least one of certain exemplary optional features shown in FIG. 29, which depicts flexible yoke alternative embodiment 210a. As shown in FIG. 29, flexible yoke 210a may in certain embodiments include serving 210a-30 to reinforce the middle portion of yoke 210a that may operatively engage bolt end 300-25; flexible yoke 210a may in certain embodiments include servings 210a-40 and 210a-41 that reinforce loops 210a-10 and 210a-11 that engage deformable thrust member 220. Alternative embodiment yoke 210a also comprises d-loop 210a-50 configured to engage certain embodiments of yoke retainer 230-20; FIGS. 2, 18, and 21, for example, show yoke retainer 230-20 defining a first finger and a second finger; certain alternative yoke retainer 230-20 embodiments may be provided with only a first finger; certain alternative yoke retainer 230-20 embodiments may be provided with more than two fingers; certain alternative yoke retainer 230-20 embodiments may include caliper jaws configured to releasably lock together to engage at least one portion of yoke 210, such as d-loop 210a-50.

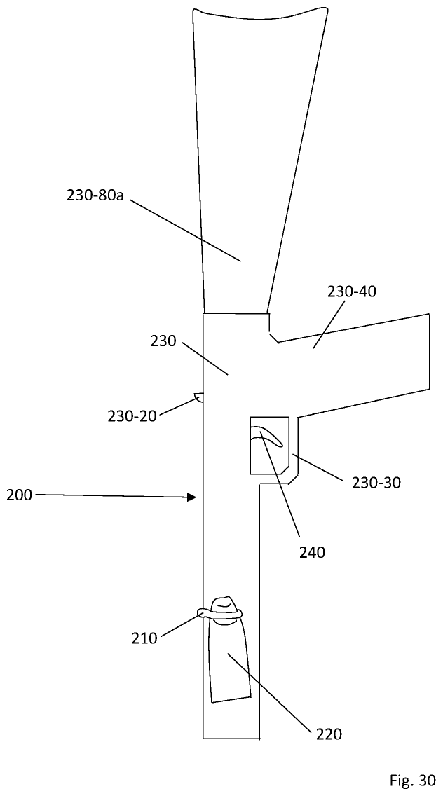

FIG. 30 shows an alternative embodiment in which pistol crossbow 200 comprises butt stock 230-80a. FIG. 31 shows an alternative embodiment in which pistol crossbow 200 comprises butt stock 230-80b. As shown in FIG. 31, although referred to as a pistol crossbow, certain embodiments of pistol crossbow 200 may not include a pistol-style handle such as handle 230-40 shown in FIG. 30 and certain other figures. Butt stock embodiments 230-80a and 230-80b are exemplary subvariants of butt stock 230-80. In certain embodiments, butt stock 230-80 may be coupled detachably to another portion of stock 230. Alternatively, butt stock 230-80 may be formed as an integral part of stock 230. In certain embodiments, butt stock 230-80 may be telescopingly coupled to another portion of pistol crossbow 200, and in certain embodiments butt stock 230-80 may be foldingly coupled to another portion of pistol crossbow 200.

FIG. 32A shows additional optional features that certain alternative embodiments of pistol crossbow 200 may comprise. FIG. 32B shows an unobstructed view of some of the elements which are shown as being internally mounted within stock 230 in FIG. 32A. Bolt retention clip 230-920 comprises resiliently flexible arm 230-925 coupled to hood 230-90, wherein resiliently flexible arm 230-925 is shaped to engage bolt 300 and urge bolt 300 against stock 230 when bolt 300 is in loaded position. Anti-dry fire disengage lever 230-50 is displaceably coupled to hood 230-90. Trigger 230-40 is coupled to push bar 230-42, sear 230-44 defines point 230-442 configured to engage notch 230-462 of nut 230-46 when in cocked position. Pressing trigger 230-40 backwards moves linked push bar 230-42 against sear 230-44, causing sear 230-44 to rotate about sear pin 230-444, thereby moving point 230-442 forward and away from engagement with notch 230-462, thereby freeing nut 230-46 to rotate about nut pin 230-464. Anti-dry fire linkage arm 230-48 is provided with linkage arm notch 230-482 configured to be capable of engaging bottom point 230-446 of sear 230-44. Bolt 300 may be sized and shaped to cooperatingly engage disengage lever 230-50 and as bolt 300 is positioned such that bolt end 300-25 engages flexible yoke 210, bolt end 300-25 or other portion of shaft 300-20 is configured to displace lever 230-50 to rotate about anti dry fire disengage lever pin 230-54, wherein curved cam surface 230-52 causes linkage arm 230-48 to rotate around linkage arm pin 230-484, thereby moving notch point 230-486 away from engagement with sear bottom point 230-446 and thereby freeing sear 230-44 to rotate when pushed by push bar 230-42. Certain embodiments may comprise certain one or more pins configured with a first end uncovered, such as pin 230-484 and 230-54 as depicted in FIG. 32A; certain embodiments may comprise certain one or more pins configured with a first end covered, such as when stock 230 defines internal sockets to receive such a covered first pin end, as may be the case for pins 240-04, 230-444, and 230-464 as depicted in FIGS. 32A and 32B. FIGS. 32A and 32B depict an exemplary embodiment of a multi-part trigger system; certain embodiments of the instantly disclosed launch system may comprise alternative embodiments of a multi-part trigger system that include a subset of the elements depicted in FIGS. 32A and 32B, and in certain alternative embodiments a multi-part trigger system may include elements other than those depicted in FIGS. 32A and 32B. Shapes and proportions of trigger system elements may be other than those depicted in FIGS. 32A and 32B.

Whereas FIGS. 32A and 32B depict an exemplary embodiment of a multi-part trigger system, FIG. 31 depicts an exemplary embodiment of a trigger system which may be substantially one-piece. Trigger 240 is shown formed integrally with push arm 242-02a, with monolithic trigger body configured to rotate around trigger pin 240-04a. Stock 230 is integrally provided with yoke retainer 230-20a defined by notch 230-20a integrally formed in stock 230. Pressing trigger 240 backwards causes rotation of monolithic trigger body around trigger pin 240-04a causing push arm 242-02 to disengage yoke 210 from notch 230-20a. Curved arrow RLC and curved arrow TPC respectively indicate the general direction of rotation of trigger 240 and the general direction of rotation of push arm 242-02a when the user uses trigger 240 to disengage yoke 210 from notch 230-20a.

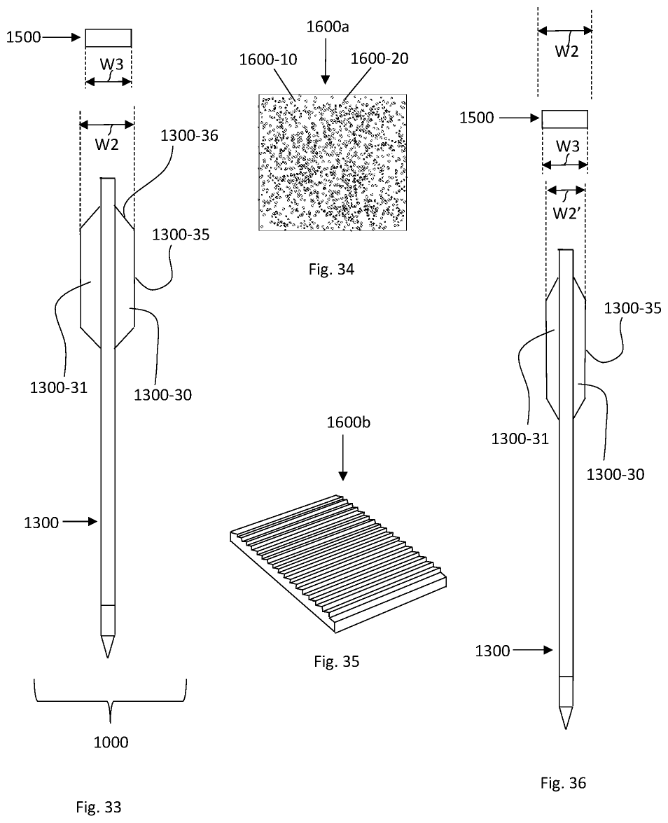

FIGS. 33-37 depict components of apparatus kit system 1000.

FIG. 33 shows kit system 1000 comprising first pistol crossbow bolt 1300 and first gas seal 1500.

Certain embodiments of kit system 1000 may further include processing tool 1600. FIG. 34 shows processing tool embodiment 1600a wherein processing tool 1600a comprises an abrasive medium, such as, for example, sandpaper. As shown in FIG. 34, a plurality of abrasive particles, such as first abrasive particle 1600-20, are mounted on flexible base 1600-10 to provide an abrasive surface suitable for removing material from first vane 1300-30 of bolt 1300; flexible base 1600-10 may comprise at least one layer of paper and/or cloth. Certain alternative variants of processing tool 1600a may include a substantially rigid base instead of or in addition to a flexible base, such as an emery board. Processing tool 1600a shown in FIG. 34 is a composite of abrasive particles and support base; certain alternative embodiments of processing tool 1600a may be other composite tools, while certain other alternative embodiments of processing tool 1600a may be monolithic. Some alternate variants of processing tool 1600a may feature an abrasive surface formed by methods such as but not limited to stamping, etching, and machining a texture into a base that may be composed of at least one of materials such as, for example, metal and ceramic. Some alternative variants of processing tool 1600a may include at least one of a monolithic abrasively surfaced body such as, for example, a pumice stone and/or a whetstone.

FIGS. 35 and 37 show processing tool embodiment 1600b wherein processing tool 1600b comprises file 1600b-10 provided with an abrasive surface comprising a plurality of ridges such as exemplary ridge 1600b-20, wherein the plurality of ridges defining edges such as exemplary edge 1600b-25 configured to assist in removing material from first vane 1300-30d. Processing tool 1600a, 1600b, and/or other embodiment variants of processing tool 1600 may be coupled to one or more components of a blowgun, quiver, pistol crossbow, and other component of kit system 1000; certain such embodiment variants of processing tool 1600 may be formed integrally in some portion of a component of kit system 1000 such as a blowgun, crossbow, quiver, and the like. Certain processing tool 1600 embodiments may be coupled to a blowgun, quiver, and/or other accessory, and in certain embodiments may be formed integrally with a blowgun, quiver and/or other accessory. Certain embodiments of processing tool 1600 may be composed at least in part of metal, which in certain embodiments may be tempered and/or hardened; certain embodiments of processing tool 1600 may composed at least in part of ceramic. Certain embodiment versions of processing tool 1600 may include a relatively coarse tooth to facilitate relatively rapid removal of material from first vane 1300-30d; certain versions may include a relatively fine tooth to facilitate smoothing and finishing of first vane 1300-30; certain versions may include at least two distinct grades of tooth.

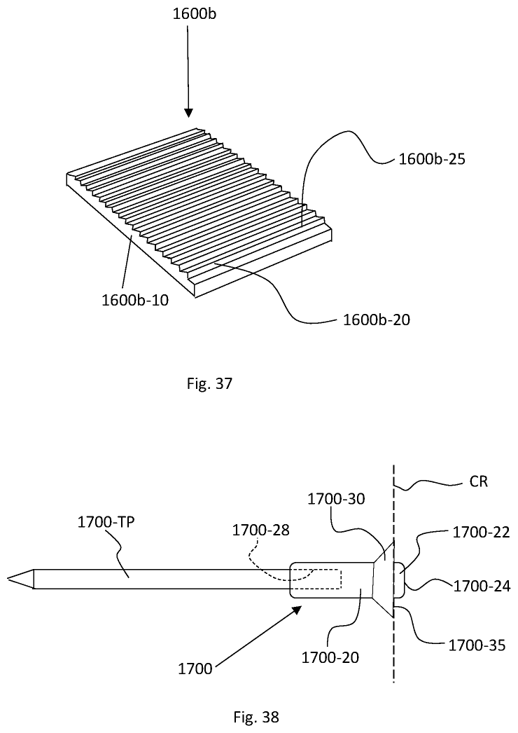

FIG. 36 shows first pistol crossbow bolt 1300 after using processing tool 1600 to process first vane 1300-30 to an exemplary second shape-size state different than the exemplary initial shape-size state of vane 1300-30 shown in FIG. 33; change in shape-size state may include change in the size or the shape or both the size and the shape of first vane 1300-30. As shown in FIG. 33, certain embodiments may include first pistol crossbow bolt 1300 wherein bolt 1300 initially defines a maximum transverse width W2 greater than maximum transverse width W3 of first gas seal 1500. FIG. 36 shows processed bolt 300 after processing with processing tool 1600, wherein processed bolt 1300 defining maximum transverse width W2′ not exceeding maximum transverse width W3 of first gas seal 1500. In certain embodiments, the initial shape-size state of bolt 1300 may be as in FIG. 36, wherein before processing by processing tool 1600 bolt 1300 initially defines a maximum transverse width W2 that does not exceed maximum transverse width W3 of first gas seal 1500. FIG. 37 is an enlarged view of FIG. 35. As shown in FIGS. 33 and 36, first vane 1300-30 may define lateral edge 1300-35 and trailing edge 1300-36; in certain alternate embodiments, lateral edge 1300-35 and trailing edge 1300-36 may smoothly merge into one another, an example being an alternate embodiment of first vane 1300 having a substantially parabolic shape substantially similar to the shape of first vane 300a-30 shown in FIG. 26.

FIGS. 38 through 43 show methods of using a PPECS dart stabilizer and embodiments of a system comprising first PPECS dart stabilizer 1700 and first gas seal 1800; certain embodiments may further comprise dart tip 1700-TP configured to be operationally coupled to PPECS dart stabilizer 1700.

PPECS dart stabilizer 1700 is provided with conical skirt 1700-30 defining substantially circular rim 1700-35 defining implied plane CR. Conical skirt 1700-20 is coupled to medial portion 1700-20. Medial portion 1700-20 includes rearward medial portion 1700-22, wherein rearward medial portion 1700-22 defines substantially blunt peg end 1700-24 located in spaced relation to circular rim 1700-35, wherein rearward medial portion 1700-22 intersecting implied plane CR defined by circular rim 1700-35. FIGS. 38 through 40 depict rearward medial portion 1700-22 protruding rearwardly beyond implied plane CR defined by circular rim 1700-35; in certain alternative embodiments, rearward medial portion 1700-22 may define peg end 1700-24 substantially coplanar with implied plane CR defined by circular rim 1700-35. FIGS. 41 and 43 depict PPECS dart stabilizer 1700b having a configuration wherein the forward transition 1700b-TR between medial portion 1700b-20 and conical skirt 1700b-30 is more gradual than the more sharply defined transition 1700-TR between medial portion 1700-20 and conical skirt 1700-30 depicted in the embodiment of FIG. 40. PPECS dart stabilizer 1700b as depicted in FIGS. 41 and 43 is configured with rearward medial portion 1700b-20 having a narrower width than the width of medial portion 1700b-20 forward of conical skirt 1700b-30. Certain embodiments of general PPECS dart stabilizer 1700 and variants such as 1700b may be formed by injection molding, and certain embodiments of general PPECS dart stabilizer 1700 and variants such as 1700b may be monolithic structures composed of plastic resin.

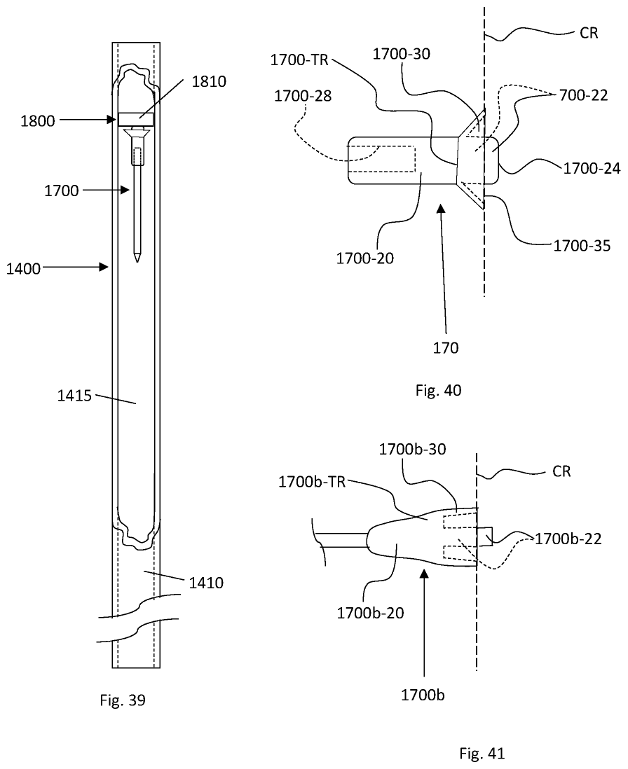

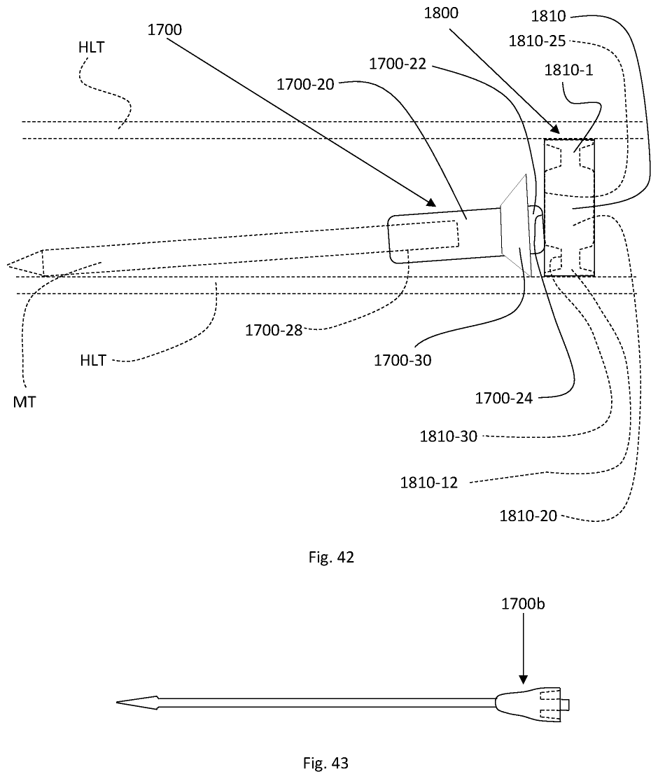

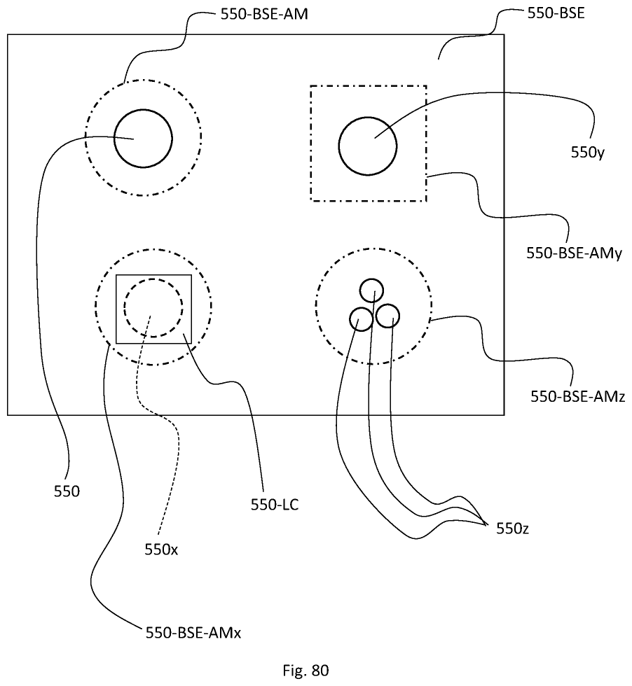

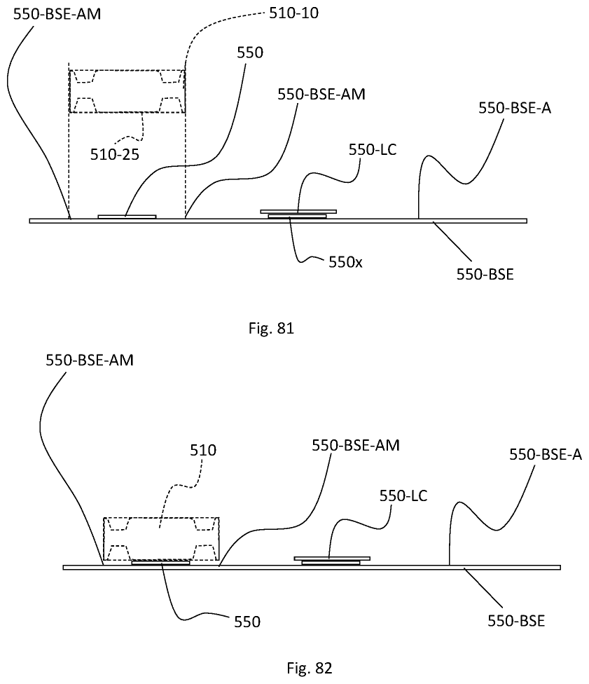

FIGS. 39 and 42 are respectively top and side views of first PPECS stabilizer 1700 disposed with peg end 1700-24 engaged against gas seal bulkhead 1810 of first gas seal 1800. FIG. 42 depicts an embodiment having support column face 1810-25 defined by central support column 1810-20 of first gas seal 1800, wherein central support column 1810-20 and lateral flange 1810-12 define annular groove 1810-30 therebetween. FIG. 42 depicts peg end 1700-24 engaged against column face 1810-25; in certain embodiments, such as the one shown in FIGS. 80 and 81, first gas seal 1800 may include an element such as label 550 that intervenes between column face 1810-25 and peg end 1700-24. In certain embodiments, such as the one shown in FIG. 42, gas seal bulkhead 1810 may comprise plastic resin body 1810-1 designed to be suitable for use as a nonintegral overpowder obturator in a shotgun shotshell fueled by dry chemical propellant. FIG. 39 shows a cutaway view of hollow launch tube 1410 to provide a direct view of PPECS stabilizer 1700 and first gas seal 1800 within passageway 1415. FIG. 42 shows a direct view of PPECS stabilizer 1700 and first gas seal 1800 with dashed lines indicating how PPECS stabilizer 1700 and first gas seal 1800 may be disposed within an internal passageway of a hollow launch tube (dashed lines HLT) and how PPECS stabilizer 1700 may be coupled to an exemplary optional metal tip (dashed lines MT) engaged within optional stabilizer socket 1700-28. PPECS stabilizer 1700 and first gas seal 1800 may be provided in combination for use in a hollow launch tube; certain such combination embodiments may further comprise optional elements such as, but not limited to, a metal tip, such as 1700-TP, configured to couple to PPECS stabilizer 1700, and a hollow launch tube, such as hollow launch tube 1400, configured to be substantially slideably partitioned by first gas seal 1800. PPECS stabilizer 1700 and first gas seal 1800 may be provided in combination as an accessory kit and/or as part of a system comprising other system elements such as a hollow launch tube exemplified by hollow launch tube 1400.

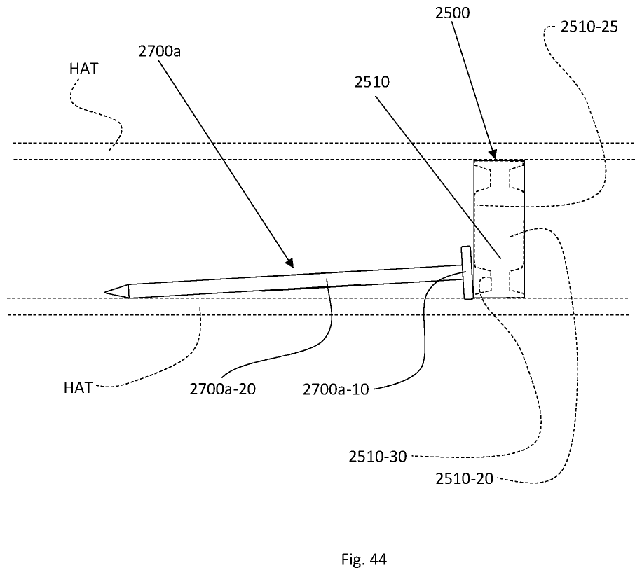

FIGS. 44 through 57 show a method of driving a hardware fastener, comprising the following steps: a) providing a first hardware fastener comprising a monolithic metal body defining an elongate shaft and a driving head; b) providing a first gas seal comprising a bulkhead, said bulkhead comprising a plastic resin body designed to be suitable for use as a nonintegral overpowder obturator in a shotgun shotshell fueled by dry chemical propellant; and c) providing a hollow acceleration tube reciprocally dimensioned for breath-driven acceleration of said first gas seal and said first hardware fastener therewithin; wherein steps a, b, and c are in no particular order with respect to one another. Certain method variants may further comprise the following step: d) Pressurizing said hollow acceleration tube with breath to accelerate said first gas seal and said first hardware fastener therewithin toward a construction workpiece, wherein said first hardware fastener impacting said workpiece and at least partially driving into said workpiece; wherein step d occurs later than steps a, b, and c, and wherein according to certain method variants, step d further including touching said construction workpiece with a stabilizer leg coupled to said hollow acceleration tube, wherein said stabilizer leg assisting to stabilize said hollow acceleration tube in spaced relation to said workpiece during acceleration of said first gas seal and said first hardware fastener. Certain method variants may further comprise the following step: e) using at least one driver tool to continue driving said first hardware fastener farther into said construction workpiece, wherein step e occurs later than step d.

Said at least one driver tool may comprise, for example, at least one hand tool and/or at least one power tool; wherein said at least one hand tool may comprise, for example, a hammer, a screwdriver, and/or a nut driver; wherein said at least one power tool may comprise, for example, a cordless battery-powered screwdriver and/or an electric drill. The method may further comprise at least one of the following steps: capturing said first gas seal in a container after acceleration and/or impact with at least one of said workpiece and said fastener when said fastener is at least partially embedded in said workpiece; reusing said first gas seal after impact with at least one of said workpiece and said fastener when said fastener is at least partially embedded in said workpiece; and cutting said first hardware fastener when said fastener is partially embedded in said workpiece.

FIGS. 44 through 57 also depict additional optional steps and method variants, and illustrate the disclosure of a system comprising, in combination, a payload piece accelerator comprising a hollow acceleration tube and a gas seal operatively associated with said hollow acceleration tube, said hollow acceleration tube defining a curved interior face, said hollow acceleration tube configured to be capable of being pressurized by breath, said first gas seal comprising a plastic resin bulkhead, said bulkhead being provided with a lateral flange and a medial support column defining a forwardly opening annular groove therebetween, wherein said bulkhead defining a maximum bulkhead width. The system may further comprise additional elements, such as a first hardware fastener comprising a monolithic metal body defining an elongate shaft coupled to a substantially blunt head configured to engage at least one driver tool cooperably configured to assist in driving said fastener at least partially into a workpiece. Certain alternative embodiments may comprise a leg for touching a workpiece surface and/or other surface while said hollow acceleration tube is disposed in spaced relation to the said workpiece surface, and certain embodiments may include a shield for intercepting said first gas seal on at least one rebound trajectory after impact with said workpiece and/or said first hardware fastener when said first hardware fastener being at least partially driven into said workpiece. Certain alternative embodiments may comprise a first hardware fastener composed at least in part of plastic resin in lieu of a first hardware fastener composed of metal.

FIGS. 44 through 46 show embodiments of first hardware fastener 2700 and of first gas seal 2500. FIG. 44 shows first hardware fastener 2700, embodied as common nail 2700a, engaged against first gas seal 2500 within a hollow acceleration tube HAT implied by dashed lines, with head 2700a-10 of common nail 2700a-10 aligned to partially engage support column face 2510-25 of support column 2510-20. Monolithic common nail 2700a also defines elongate shank 2700a-20 integrally coupled to head 2700a-10. Common nail 2700a is exemplary of certain types of hardware fastener nails that are provided with a relatively wide head having a width greater than the width of annular groove 2510-30.

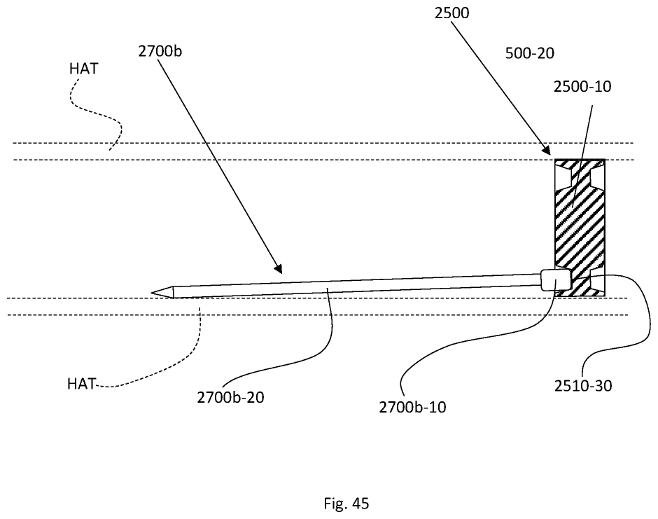

FIG. 45 shows first hardware fastener 2700 embodied as monolithic trim nail 2700b, engaged against first gas seal 2500, with head 2700b-10 of trim nail 2700b aligned to engage annular groove 2510-30. Monolithic trim nail 2700b also defines elongate shank 2700b-20 integrally coupled to head 2700b-10. Trim nail 2700b is exemplary of certain types of hardware fastener nails that are provided with a relatively narrow head having a width not exceeding the width of annular groove 2510-30.

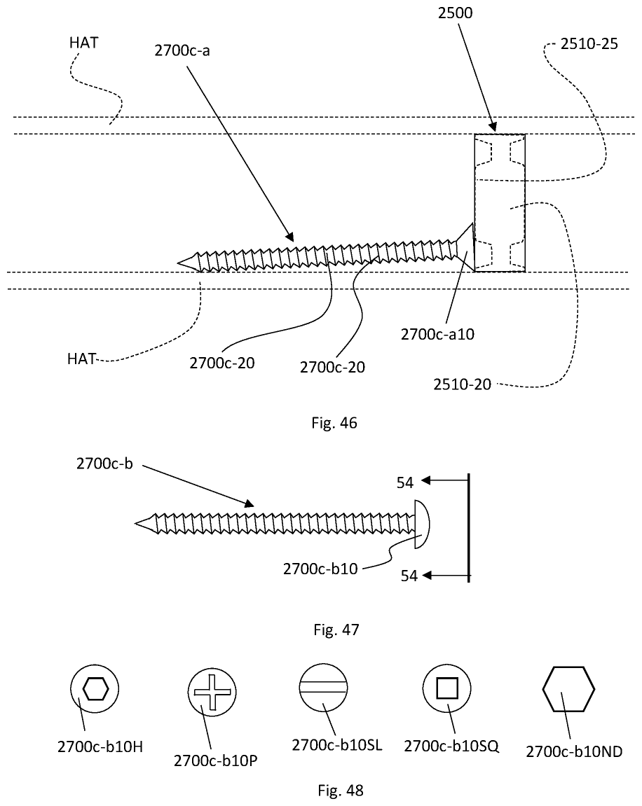

FIG. 46 shows first hardware fastener 2700, embodied as screw 2700c, engaged against first gas seal 2500, with head 2700-10c defined by screw 2700c aligned to partially engage support column face 2510-25. Monolithic screw 2700c also defines elongate shank 2700c-20 integrally coupled to head 2700c-10, elongate shank 2700c-20 being provided with threads 2700c-25. Screw 2700b is exemplary of certain types of hardware fastener screws that may be provided with various types of heads.

FIG. 46 shows first hardware fastener screw embodiment 2700c-a provided with countersunk flat head 2700c-a10, and FIG. 47 shows first hardware fastener screw embodiment 2700c-b provided with round head 2700c-b10. FIG. 48 shows multiple versions of head 2700c-b10 from the view along line 54 from FIG. 47, provided with exemplary variants of the screw driver system that may be provided for engaging a driver tool such as, for example, a screwdriver; the exemplary head versions are also generalizable to 2700c-a and as well to other embodiments of first hardware fastener screw 2700c, the b10 suffix used in the numbering of FIG. 48 being nonlimiting. Head 2700c-b10H is provided with a hex socket screw drive designed to be compatible with a hex driver tool such as a hex key, also known as an Allen wrench; head 2700c-b10P is provided with a cross-slotted recess designed to be compatible with a crosshead screw driver tool such as that found in a Phillips head screwdriver; head 2700c-b10SL is designed to be compatible with a slotted screwdriver, also known by terms such as slot, flat-blade, common, and standard screwdriver; head 2700c-b10SQ is provided with a square socket designed to be compatible with a Robertson drive head and/or other square screw drive head. Head 2700c-b10ND is designed to be compatible with the socket of a nut driver tool. The head versions shown in FIG. 48 are nonlimiting and exemplary of the many types of screw drive system configurations that may be employed in screws currently and/or in the future.

First hardware fastener embodiments 2700-a, 2700-b, and 2700-c are exemplary of certain hardware fasteners that may in certain embodiments and methods of use be coupled to at least one additional element, such as a washer, gasket, and the like, that is accelerated along with first hardware faster 2700 and first gas seal 2500.

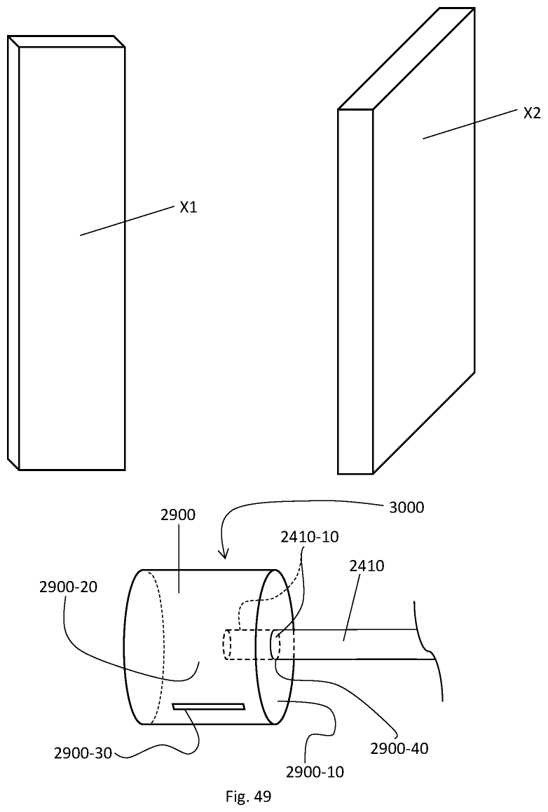

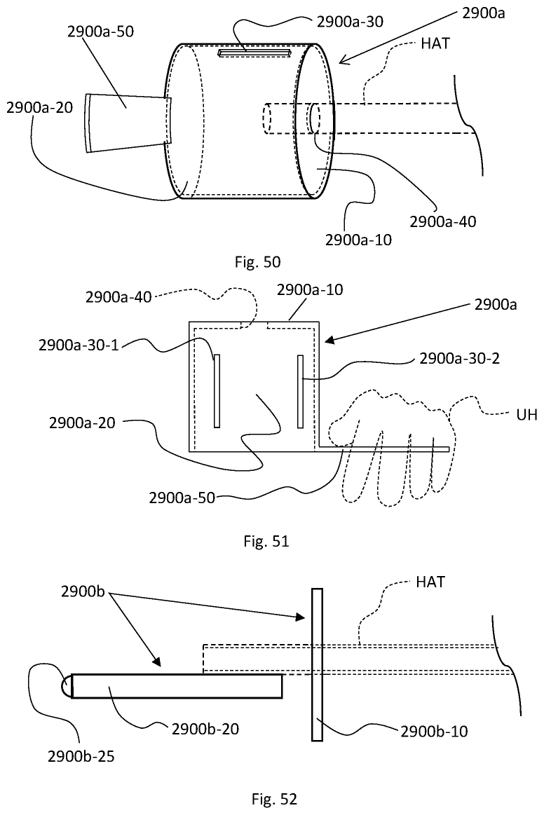

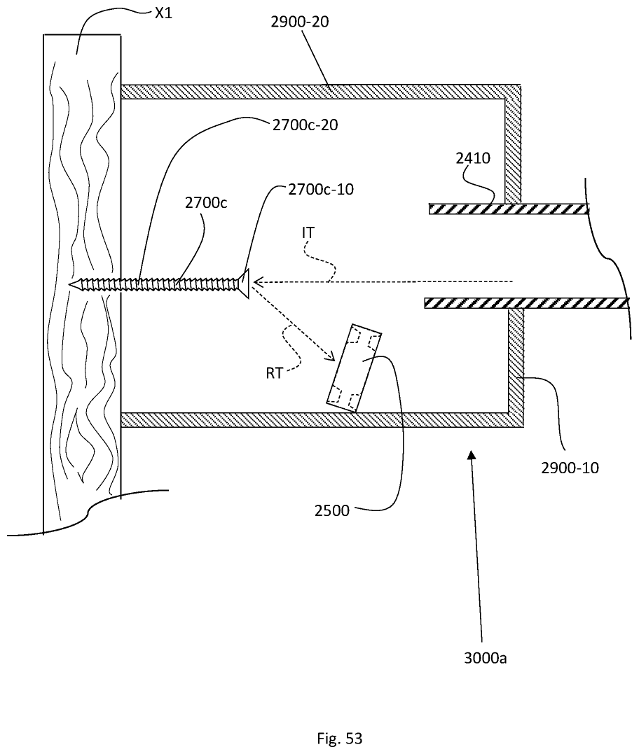

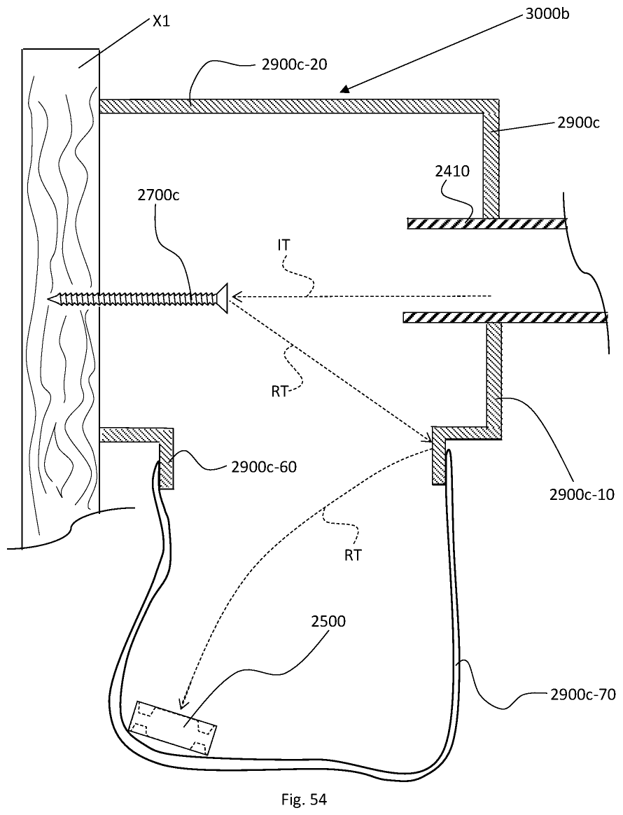

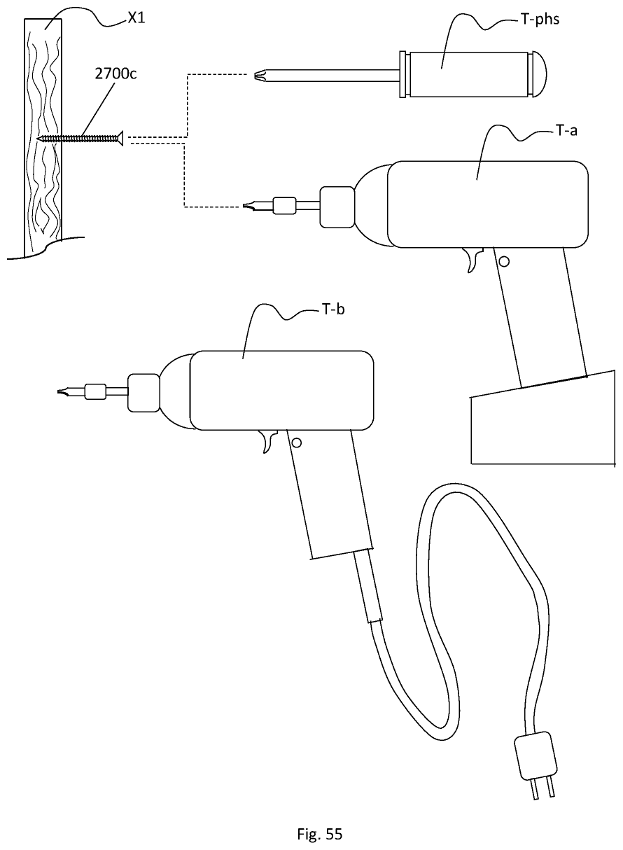

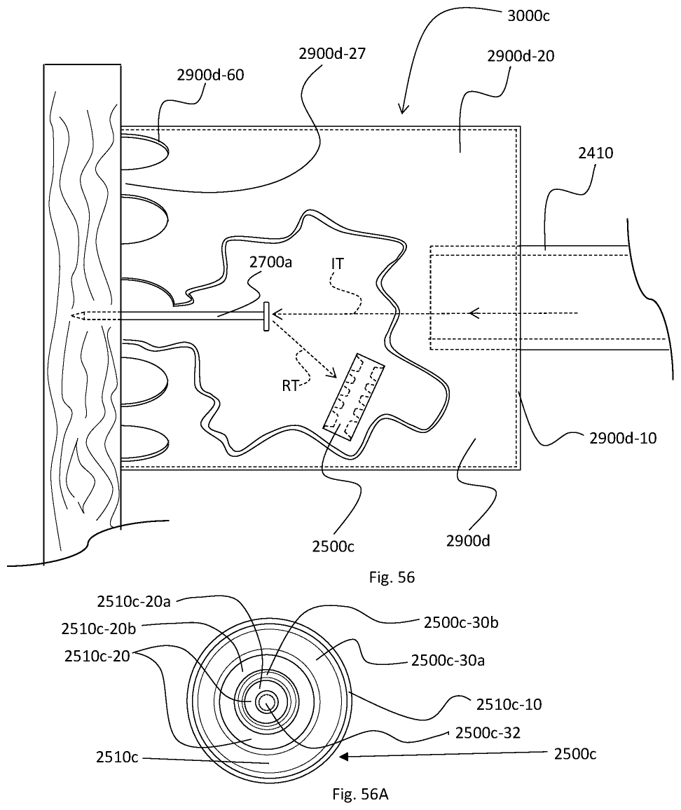

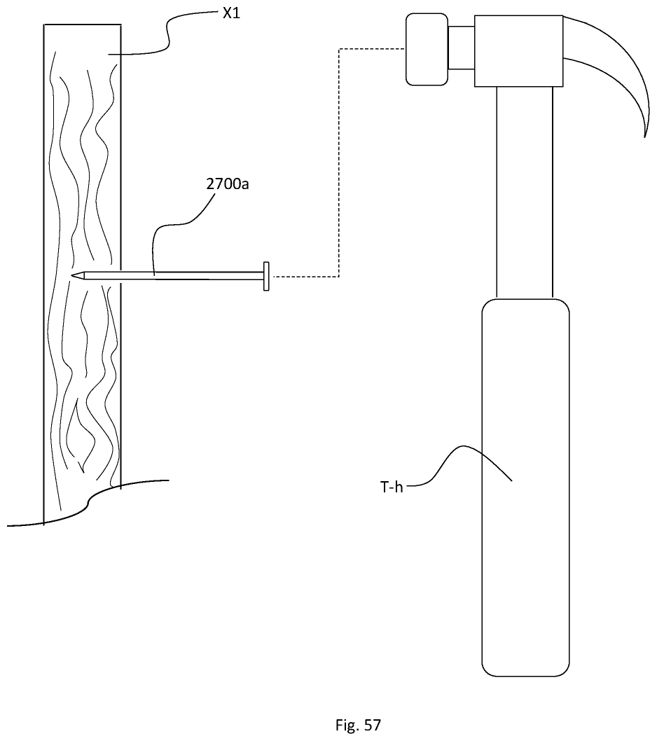

FIG. 49 shows fastener driver system 3000 comprising deflector shield 2900 coupled to hollow acceleration tube 2410. FIG. 49 shows hollow acceleration tube 2410 broken to not show the proximal end due to drawing scale and with distal end 2410-10 of acceleration tube 2410 coupled to deflector shield 2900 at receptacle aperture 2900-40. In this embodiment, deflector shield 2900 monolithically defines proximal shield 2900-10 and hollow leg 2900-20, leg 2900-20 being provided with exhaust air port 2900-30. A portion of acceleration tube proximal end 2410-10 is shown protruding within hollow leg 2900-20; however, in certain embodiments proximal end 2410-10 may not substantially protrude beyond deflector shield 2900-10. FIG. 49 also shows workpiece X1 and workpiece X2, which are representative of construction workpieces such as wooden planks, wooden beams, wooden boards, plywood, drywall, and the like.

FIGS. 50 and 51 show deflector shield alternate embodiment 2900a. In FIGS. 50 and 51, deflector shield embodiment 2900a is provided with stirrup 2900a-50, stirrup 2900a-50 being designed to be capable of being placed against and possibly under the user's hand, foot, and the like (dashed line UH) to provide additional stabilization when engaging a workpiece, with the understanding that being against the user's hand and/or foot can include situations such as in which the user's hand may be within a glove and/or the user's foot may be within footwear such as a shoe. FIG. 50 shows deflector shield 2900a defining exhaust air port 2900a-30 and FIG. 51 shows deflector shield 2900a comprising plurality of air exhaust ports 2900a-30-1 and 2900a-30-2. Deflector shield 2900a defines proximal shield 2900a-10, hollow leg 2900a-20, and receptacle aperture 2900a-40 designed for insertion of a hollow acceleration tube HAT (dashed lines in FIG. 50) shown broken to not show the proximal end due to drawing scale.

FIG. 52 shows alternate deflector shield embodiment 2900b in which leg 2900b-20 and proximal shield 2900b-10 are nonintegral with one another, with each being coupled to a hollow acceleration tube HAT. Leg 2900b-20 is solid in this embodiment but may be hollow in certain alternate embodiments. Leg 2900b-20 in this embodiment is provided with optional rounded foot 2900b-25; certain alternative embodiments may additionally or alternatively have a substantially flat foot, while certain alternative embodiments may additionally or alternatively have a substantially pointed foot. Foot 2900b-25 may in certain embodiments be composed of a material with shock-absorbing and/or skid-resistant properties, such as rubber, polyurethane, and the like.

FIGS. 53 through 60 show methods of driving exemplary hardware fasteners, and additional alternate fastener driver system embodiments provided by the general method. FIG. 53 shows fastener driver system 3000a comprising hollow leg 2900-20 coupled to hollow acceleration tube 2410 with associated first gas seal 2500 and associated first hardware fastener 2700 embodied as exemplary embodiment 2700c. FIG. 53 shows hollow leg 2900-20 engaged against workpiece X1; first hardware fastener 2700 and first gas seal 2500 are accelerated pneumatically within hollow acceleration tube 2410 along impact trajectory (dashed arrow IT), thereby driving fastener shank 2700-20 at least partially into workpiece X1, first gas seal 2500 rebounding along rebound trajectory (dashed arrow RT) and being intercepted by deflector shield 2900; gas seal 2500 may be intercepted by hollow leg 2900-20 or by proximal shield 2900-10 or by both hollow leg 2900-20 and proximal shield 2900-10. It will be understood accordingly that hollow leg 2900-20 also may function as a lateral shield to help intercept and contain gas seal 2500. FIG. 53 depicts impact trajectory IT of gas seal 2500 coinciding with head 2700c-10 of first hardware fastener 2700c when fastener shank 2700c-20 is embedded at least partially into workpiece X1; other impact trajectories of gas seal 2500 are possible, and certain of such impact trajectories may not coincide with fastener head 2700c-10. Certain impact trajectories of gas seal 2500 may additionally or alternatively coincide with some portion of workpiece X1. In certain embodiments and in certain methods of use, certain rebound trajectories of gas seal 2500 may not be intercepted by deflector shield 2900.

FIG. 54 shows fastener driver system embodiment 3000b comprising hollow leg 2900c coupled to hollow acceleration tube 2410 with associated first gas seal 2500 and associated first hardware fastener 2700c. FIG. 54 shows hollow acceleration tube 2410 coupled to alternate deflector shield embodiment 2900c defining hollow leg 2900c-20 and proximal shield 2900c-10, wherein hollow leg 2900c-20 is provided with air exhaust port 2900c-60 and collection bag 2900c-70 coupled to hollow leg 2900c-20. Collection bag 2900c-70 may be flexible in certain embodiments and may in certain embodiments define interstices, such as in a mesh; in certain embodiments a substantially rigid collection container may alternatively or additionally be provided.

FIG. 55 shows using some exemplary driver tool T variants which may be used singly or in combination to drive fastener 2700c further into workpiece X1 after acceleration according to the method exemplified in FIGS. 53 and 54. According to certain embodiments and/or methods of use, driver tool T may be a hand tool, such as screwdriver T-phs shown provided with a Phillips tip. Alternative driver tool embodiment T-a is a power tool provided with a battery and a slotted screwdriver bit. Alternative driver tool embodiment T-b is a power tool provided with a power cord configured to plug into an electrical outlet. As will be apparent to one skilled in the art, driver tool T alternative embodiments may be provided with other types of heads, tips, and bits; certain such heads, tips, and bits may be fixed and certain such heads, tips, and bits may be interchangeable.

FIG. 56 shows fastener driver system alternative embodiment 3000c comprising hollow acceleration tube 2410 coupled to deflector shield 2900d defining proximal shield 2900d-10 and hollow leg 2900d-20, wherein hollow leg 2900d-20 includes at least one air exhaust port 2900d-60 at the distal rim 2900d-27; as shown, in certain embodiments rim 2900d-27 may be configured to define a plurality of port openings 2900d-60 when touching workpiece X1. FIG. 56 shows hollow leg 2900d-20 partially cut away to provide a direct view of first common nail hardware fastener 2700a and alternative first gas seal embodiment 2500c, first common nail hardware fastener 2700a being partially embedded in workpiece X1 after being accelerated through hollow acceleration tube 2410, and first gas seal 2500c rebounding from indirect impact with workpiece X1 transferred through partially embedded first common nail hardware fastener 2700a. FIG. 56A shows a front view of alternative first gas seal embodiment 2500c at a somewhat enlarged scale. First gas seal embodiment 2500c comprises bulkhead 2510c provided with lateral flange 2510c-10 and medial support column 2510c-20 defining first forwardly opening annular groove 2500c-30a therebetween; medial support column 2510c-20 comprises inner ring 2500c-20a and outer ring 2500c-20b defining second forwardly opening annular groove 2500c-30b therebetween; said inner ring 2500c-20a defines medially disposed support column fossa 2500-32.

FIG. 57 shows using hammer tool T-h to drive first common nail hardware hardware fastener 2700a further into workpiece X1 after partially driving first common nail hardware fastener 2700a into workpiece X1 as shown in FIG. 56.

FIG. 58 shows a method variant which may be used to provide exemplary fastener driver alternate embodiment 3000d, wherein fastener driver embodiment 3000d comprises hollow acceleration tube 2410, associated first gas seal 2500, and associated first screw hardware fastener 2700c. FIG. 58 shows a hemisected side view of hollow acceleration tube 2410 wherein tube 2410 is provided with port 2410-60 and distal end 2410-80 of hollow acceleration tube 2410 directly engages workpiece X1. First screw hardware fastener 2700c and first gas seal 2500 are accelerated within hollow acceleration tube 2410 along impact path IP to drive first screw hardware fastener 2700c at least partially into workpiece X1, wherein first gas seal 2500 may at least temporarily remain within hollow acceleration tube 2410 after acceleration and impact, substantially in the general manner as depicted. First gas seal 2500 may remain substantially in contact with screw fastener head 2700c-10 after acceleration is complete, as depicted in FIG. 58, or may rebound and move backward some distance within hollow acceleration tube 2410.

FIG. 59A is a side view of a method variant and fastener driver exemplary alternate embodiment 3000e. Fastener driver exemplary alternative embodiment 3000e comprises hollow acceleration tube 2410, shield 2900e-10, leg 2900e-20, and associated elongate fastener pin 2750, wherein hollow acceleration tube 2410 is coupled to shield 2900e-10 and to leg 2900e-20. Elongate fastener pin 2750 is accelerated through hollow acceleration tube 2410 along impact trajectory IT. Although, in the embodiment shown in FIGS. 59A and 59B, elongate fastener 2750 does not define a head portion, certain embodiments may include a head portion similar to 2700a-10, 2700b-10, and the like. FIG. 59B shows fastener pin 2750 after having been driven through workpiece X1 and into workpiece X2. As shown in FIG. 59B, pin 2750 may optionally be cut with cutter tool T-x such that embedded portion 2750-E is left embedded within workpieces X1 and X2 and remaining nonembedded portion 2750-F is released; reduced length portion 2750-F may be accelerated into a workpiece in the same manner used with the original full length fastener pin 2750; the process of cutting the embedded pin 2750, retrieving portion 2750-F, and accelerating portion 2750-F into a workpiece may be repeated, with portion 2750-F then itself being subdivided into new current portions 2750-E and 2750-F each time, until the remainder of pin 2750 is too short for continued use. According to the method shown in FIG. 59B, after fastener pin 2750 is cut, a short length of portion 2750-E protrudes from workpiece X1. However, according to certain variant methods of use, portion 2750-E may after cutting be flush with the surface of workpiece X1. In method variants in which some length of portion 2750-E protrudes out of workpiece X after cutting pin 2750, the protruding part of portion 2750-E may be bent over with an appropriate tool such as a hammer in order to provide increased holding power to secure workpieces together. The general method involving pin 2750 is useful, for example, for initially tacking together two or more workpieces before securing the workpieces together more firmly with heavier fasteners such as nails and screws. The initial length of pin 2750 may in certain embodiments exceed 12 inches. In testing using breath to accelerate an exemplary 15 inch embodiment of pin 2750 with a diameter of about 0.05 inch, pin 2750 was able to consistently penetrate at least ¾ inch into a pine board; the embedded portion was cut off and left embedded in the board and the free portion accelerated again, the process being repeated 8 times. Pin 2750 is shown initially defining a substantially blunt distal end; certain alternative embodiments may initially include a sharpened distal end, and certain cutting tools and methods of use may result in the formation of a relatively sharp distal end on current portion 2750-F. As shown in FIG. 59A, first gas seal 2500 may sometimes tumble and continue forward after impact with pin 2750. In certain cases, first gas seal 2500 may not impact pin 2750 at all when pin 2750 is embedded into workpiece X1 after acceleration, while in certain other cases, first gas seal 2500 may be impaled on pin 2750 rather than rebounding.

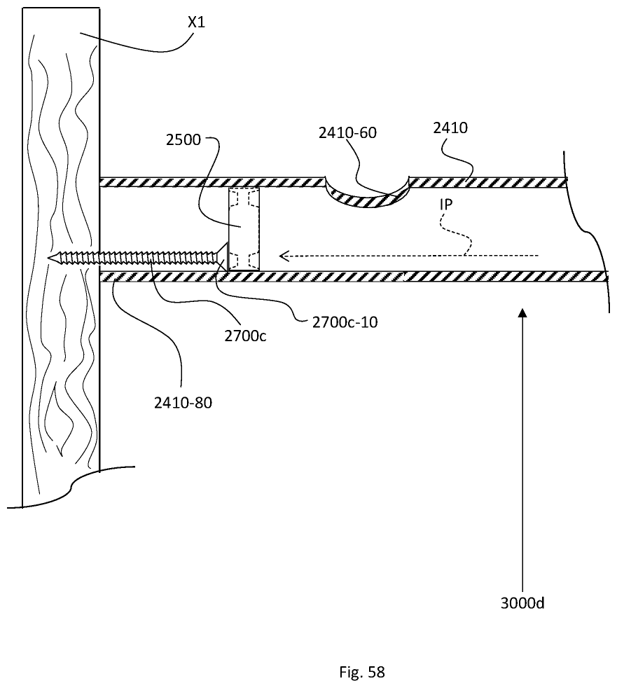

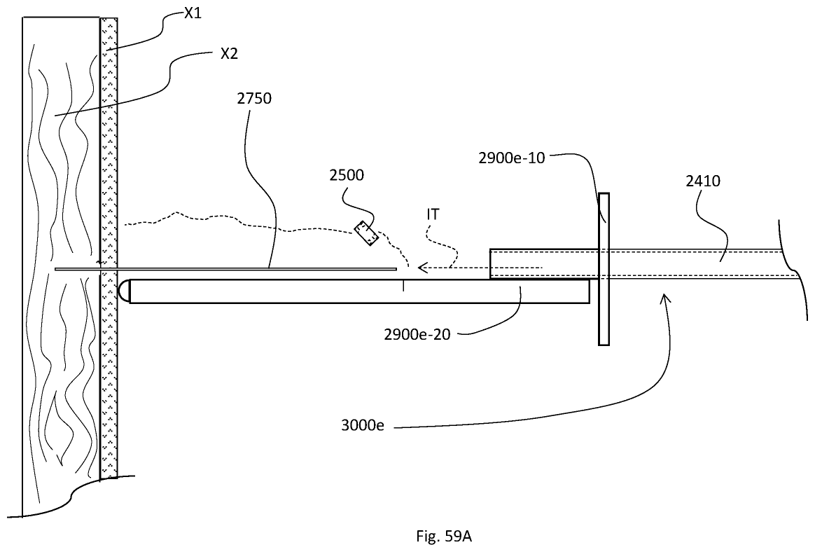

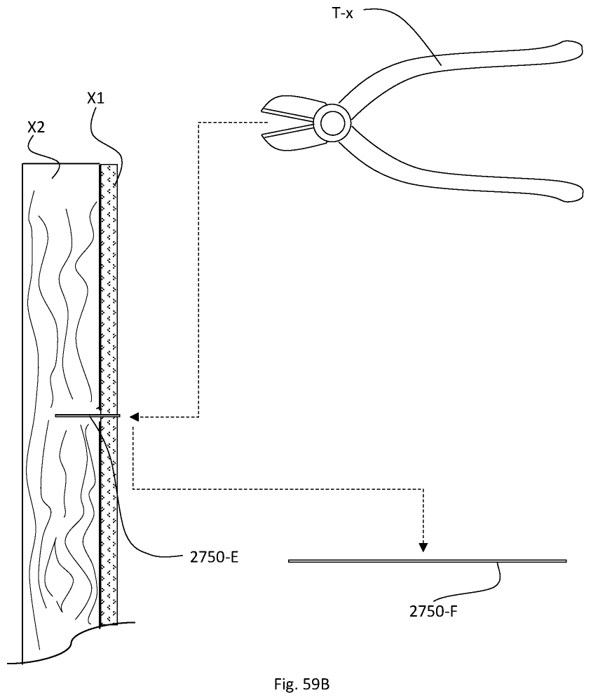

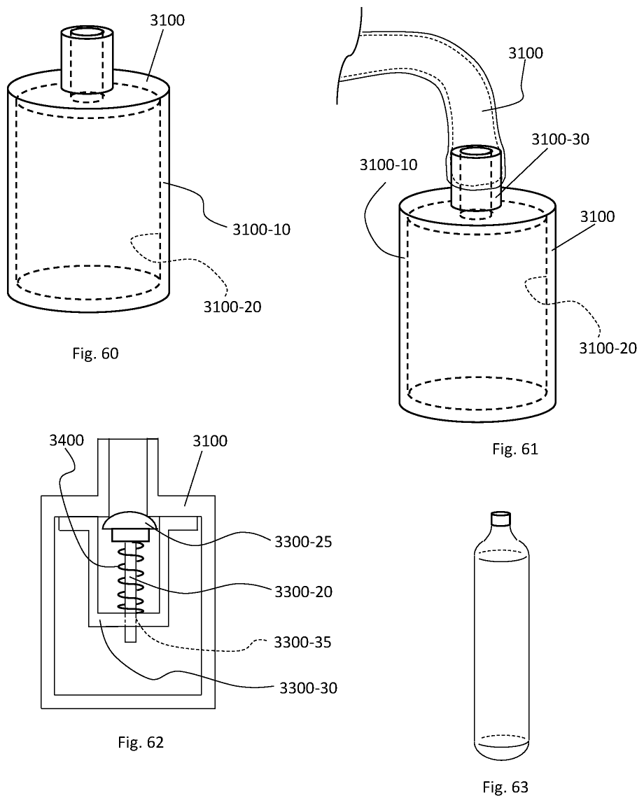

As shown in FIGS. 60 through 63, a source of compressed gas other than breath may be used to pressurize hollow acceleration tube 2410 and accelerate first gas seal 2500 and first hardware fastener 2700. FIGS. 58, 59, and 60 show pneumatic container 3100 comprising substantially cylindrical tank 3100-10 defining interior reservoir 3100-20 suitable for being charged with compressed gas. FIG. 59 shows air transfer tube 3200 coupled to stem 3100-30 of container 3100. As shown in FIG. 62, tank 3100 may be provided with internal valve components; valve sealing head 3300-10 is coupled to shaft 3300-20 passing through hole 3300-35 in bracket 3300-30 coupled to container 3100; valve spring 3400 may be provided to assist in biasing valve head 3300-25 to a closed position, although internal air pressure may additionally or alternatively apply such a bias when tank 3100 is pressurized. In certain alternative embodiments, an external valve may be coupled intermediately to container 3100 and hollow acceleration tube 2410. In embodiments that include internal and/or external valves, hollow acceleration tube 2410 is considered to be valvedly coupled to pneumatic container 3100. FIG. 63 shows a CO2 power cartridge of the general type that is commonly available in 12 gram, 88 gram, and 90 gram sizes. In certain embodiments, hollow acceleration tube 2410 may be coupled to a valve assembly including a piercing pin suitable for piercing the wall of a CO2 power cartridge and thereby providing a pressure source for pneumatically accelerating fasteners. Alternatively, hollow acceleration tube 2410 may be coupled to a valve assembly provided with a threaded connector for attaching to a CO2 power cartridge of the type provided with mating threads.

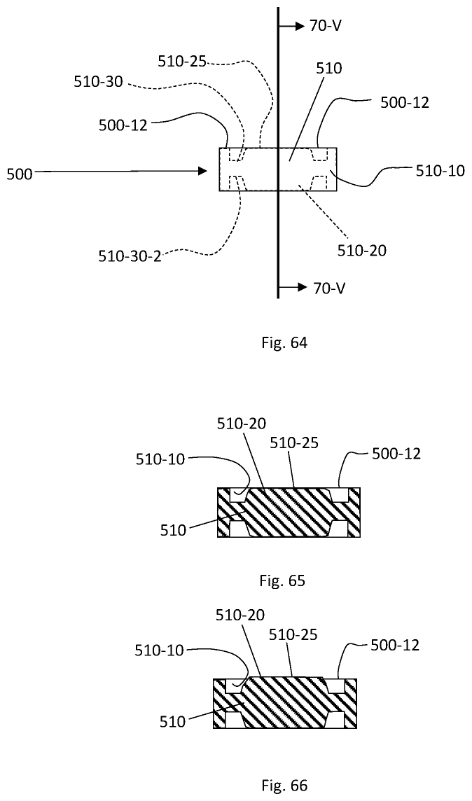

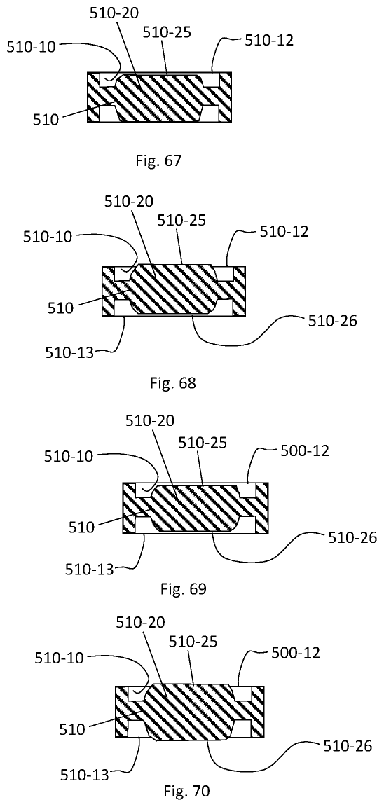

FIGS. 65 through 70 are sectional views along line 70-V of FIG. 64, each showing an exemplary alternate embodiment of first gas seal 500. First gas seal 500 comprises plastic resin body 510 provided with lateral flange 510-10 and medial support column 510-20 defining first annular groove 510-30 therebetween, wherein medial support column 510-20 defines first column face 510-25 and second column face 510-26 and wherein lateral flange 510-10 defines first rim 510-12 and second rim 510-13. In the exemplary embodiment shown in FIG. 64, plastic resin body 510 also defines second annular groove 510-30-2; certain alternative embodiments may not include second annular groove 510-30-2. FIG. 65 shows an embodiment in which first gas seal 500 defines first column face 510-25 substantially coplanar with first rim 510-12 of lateral flange 510-10. FIG. 66 shows an embodiment in which first gas seal 500 defines first column face 510-25 axially offset from and protruding forwardly beyond first rim 510-12 of lateral flange 510-10. FIG. 67 shows an embodiment in which first gas seal 500 defines first column face 510-25 axially offset from and recessed with respect to first rim 510-12 of lateral flange 510-10. FIG. 68 shows an embodiment in which first gas seal 500 defines first column face 510-25 axially offset from and protruding beyond first rim 510-12 of lateral flange 510-10 and wherein second column face 510-26 being recessed with respect to second rim 510-13 of lateral flange 510-10. FIG. 69 shows an embodiment in which first gas seal 500 defines first column face 510-25 axially offset from and recessed with respect to first rim 510-12 of lateral flange 510-10 and wherein second column face 510-26 being recessed with respect to second rim 510-13 of lateral flange 510-10. FIG. 70 shows an embodiment in which first gas seal 500 defines first column face 510-25 axially offset from and protruding beyond first rim 510-12 of lateral flange 510-10 and wherein second support column face 510-26 axially offset from and protruding beyond second rim 510-13 of lateral flange 510-10. Certain embodiments may have configurations other than those shown in the exemplary embodiments shown in FIGS. 65-70; for example, certain embodiments of first gas seal 500 may define first column face 510-25 axially offset from and protruding beyond first rim 510-12 of lateral flange 510-10 and wherein second support column face 510-26 axially offset from and protruding beyond second rim 510-13 of lateral flange 510-10. The variations in configurations of first gas seal 500 shown in FIGS. 64-70 may also apply to first gas seal 1500 shown, for example, in FIG. 42, and may also apply to first gas seal 2500 shown, for example, in FIG. 46, and may also apply to certain other gas seal embodiments used in the systems and methods herein disclosed.

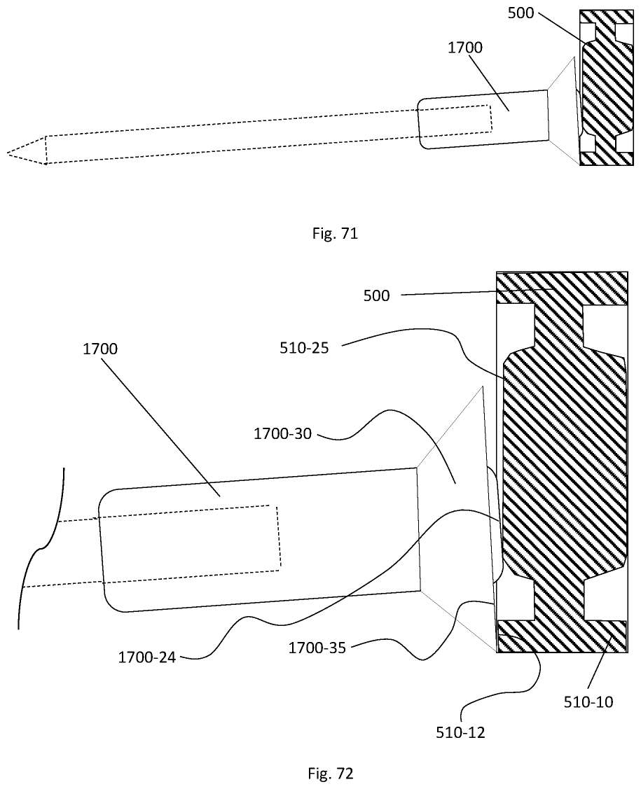

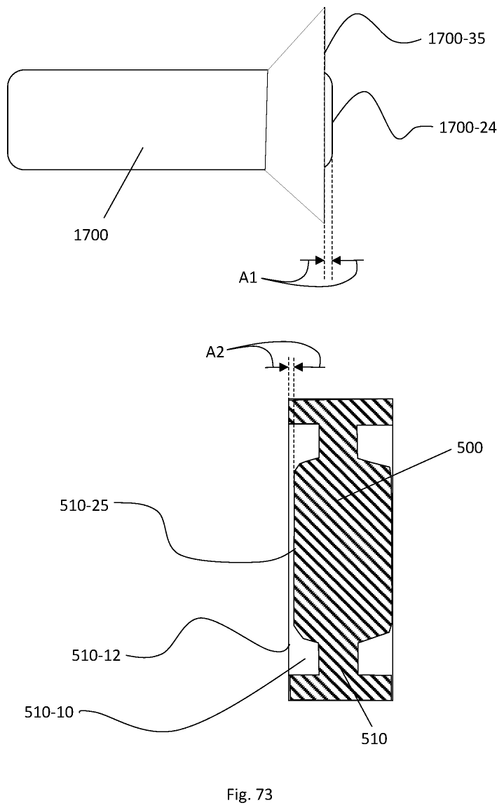

FIGS. 71 and 72 show side views of PPECS stabilizer 1700 engaged with first gas seal 500, with first gas seal 500 shown hemisected to provide a direct view of peg end 1700-24 engaging support column face 510-25 and conical skirt rim 1700-35 of conical skirt 1700-30 engaging rim 510-12 of lateral flange 510-10, with FIG. 71 showing a view at an enlarged scale relative FIG. 72. An optional tip OT is indicated by dashed lines; depending on the length of optional tip OT that may in certain embodiments be attached to PPECS stabilizer 1700, the angle at which PPECS stabilizer 1700 engages first gas seal 500 may vary, and conical skirt 1700-30 may sometimes not engage lateral flange rim 510-12 in certain embodiments and/or according to certain methods of use. These characteristics of engagement of PPECS stabilizer 1700 against first gas seal 500 may be generalized to certain other gas seal embodiments, such as, for example, first gas seal 1500 and first gas seal 2500.

FIG. 73 shows side views of an embodiment comprising PPECS stabilizer 1700 and first gas seal 500, with first gas seal 500 shown hemisected to show an unobstructed view of PPECS stabilizer 1700. PPECS stabilizer conical skirt rim 1700-35 and peg end 1700-24 mutually define axial offset A1. Gas seal support column face 510-25 and lateral flange forward rim 510-12 mutually define axial offset A2, with axial offsetA2 less than axial offset A1. It may be noted that the embodiment of first gas seal 1500 shown in FIG. 42 has axial offset A2 substantially equal to zero. Embodiments in which axial offset A2 does not exceed axial offset A1 may help to provide a stable interface for engaging PPECS stabilizer 1700 during acceleration; if axial offset A2 exceeds axial offset A1, stability may be decreased if thrust is applied to skirt rim 1700-35 while peg end 1700-24 is not engaged against gas seal support column face 510-25, and any such tendency towards decrease in stability may be exacerbated when conical skirt 1700-35 is substantially flexible. In certain embodiments, an intermediary element interposed between gas seal support column face 510-25 and PPECS stabilizer 1700 may prevent direct surface contact of gas seal 510 against peg end 1700-24, yet still permit peg end 1700-24 to essentially engage gas seal support column face 510-25 to be accelerated thereby during launch. Exemplary embodiments of an example of such an intermediary element is depicted in FIGS. 74 through 89.

FIGS. 74 through 89 depict embodiments of a method and system that may be used to increase ease in recovering first gas seal 500 after acceleration. The method comprises providing first gas seal bulkhead 510, providing first label 550 configured to be mountable to first gas seal bulkhead 510, and mounting first label 550 to first gas seal bulkhead 510 to provide first gas seal 500. A variant of the method comprises providing first gas seal bulkhead 510 and first label 550 in combination, which may be used to provide a gas seal system 500 comprising first gas seal bulkhead 510 and first label 550 configured to be mountable to first gas seal bulkhead 510; in certain embodiments of the gas seal system, first label 550 may be configured to be self-adhesive, and in certain embodiments of the gas seal system 500, first label 550 may be vividly colored. In certain embodiments, first gas seal 500 may be provided to a user with first label 550 already mounted to first gas seal bulkhead 510; certain such embodiments may be processed by automated equipment configured to automatedly mount first label 550 to first gas seal bulkhead 510. In certain embodiments, first label 550 may be provided in combination with first gas seal bulkhead 510 wherein first label 550 is initially unmounted to first gas seal bulkhead 510; in certain such embodiments, the user may mount first label 550 to first gas seal bulkhead 510, such as by manually mounting first label 550 to first gas seal bulkhead 510. In general, first label 550 may be used to help provide first gas seal 500 with enhanced visibility. In certain embodiments, first label 550 may be configured to exhibit visual contrast with first gas seal bulkhead 510, such as by having at least one of hue, saturation, and value distinct from that of first gas seal bulkhead 510. In certain embodiments, first gas seal bulkhead 510 may comprise a plastic resin body designed to be suitable for use as a nonintegral overpowder obturator in a shotgun shotshell fueled by dry chemical propellant; some such embodiments and certain other embodiments of first gas seal bulkhead 510 may originally have a color which is not necessarily eye-catching and may not be easy to spot from a distance. Mounting first label 550 to first gas seal bulkhead 510 may provide enhanced visibility for first gas seal 500 to increase ease of recovering first gas seal 500, which may fall after launch to at least one surface such as the ground, the floor, and the like. Mounting first label 550 to first gas seal bulkhead 510 may provide enhanced visibility for first gas seal 500 to increase ease of visually tracking first gas seal 500 during flight. Certain embodiments of first label 550 may be colored in bright, intense hues, and certain embodiments of first label 550 may be fluorescently colored, such as by including at least one florescent dye. Certain embodiments of first label 550 may be colored for high visual contrast with first gas seal bulkhead 510, which may help to increase visibility even if first gas seal bulkhead 510 is already vibrantly colored. Certain embodiments of first label 550 may additionally or alternatively include multiple regions that have distinct colors to create high visual contrast within first label 550 itself. Certain embodiments of first label 550 may additionally or alternatively include at least one reflective surface, and certain embodiments of first label 550 may additionally or alternatively include at least one refractive element; some such embodiments may comprise one or more elements exemplified by, but not limited to, reflective film, glitter, prismatic elements, and holographic patterns. First label 550 may additionally or alternatively include phosphorescent and/or other glow-in-the-dark features.

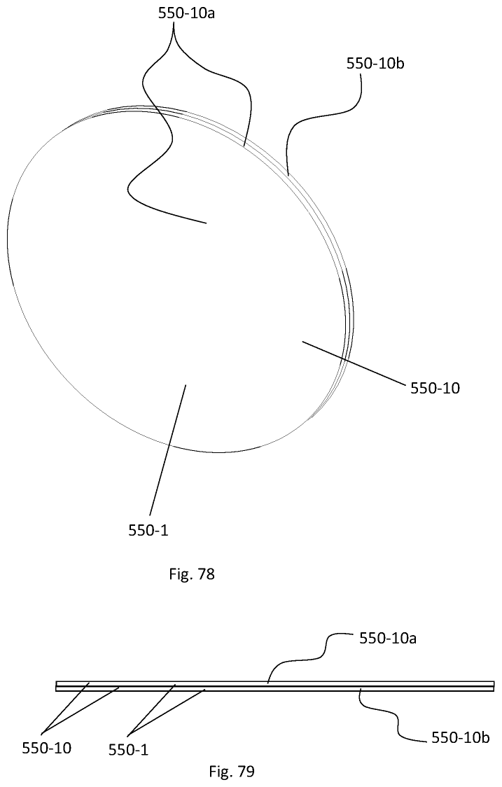

FIG. 74 shows an embodiment of first gas seal 500 wherein first gas seal 500 comprises first gas seal bulkhead 510 and first label 550, wherein first label 550 is configured to be mountable to first gas seal bulkhead 510. In the exemplary embodiment depicted, first gas seal bulkhead 510 comprises monolithic plastic resin body 510-1 designed to be suitable for use as a nonintegral over-powder obturator in a shotgun shotshell fueled by dry chemical propellant, and first label 550 comprises substantially circular disk 550-10. FIG. 75 shows first label 550 mounted to first gas seal bulkhead 510. First label 550 may in certain embodiments be designed to be self-adhesive such that first label 550 may adhere to first gas seal bulkhead 510 when mounted thereon; some such embodiments may include an adhesive layer applied to a base layer. FIGS. 78 and 79 respectively show a perspective view and a side view of an embodiment of first label 550 wherein disk 550-10 comprises base layer 550-10a and adhesive layer 550-10b. Adhesive layer 550-10b may completely cover one side of base layer 550-10a; alternatively, adhesive layer 550-10b may partially cover one side of base layer 550-10a, and in certain embodiments may be applied in a pattern such as dots, stripes, and the like. Thicknesses of base layer 550-10a and of adhesive layer 550-10b as depicted in FIGS. 78 and 79 are exemplary and nonlimiting; in certain embodiments the thickness of base layer 550-10a may be different than the thickness of base layer 550-10b. In general, although not without exception, reducing the total thickness of first label 550 may provide reduction in total mass of first gas seal 500. Base layer 550-10a is advantageously water resistant, and may be composed at least in part of flexible film composed at least in part of at least one plastic such as vinyl, polypropylene, polyester, and the like; alternatively or additionally, base layer 550-10a may comprise a fibrous layer such as, for example, at least one layer of paper and/or cloth or a combination thereof. Certain embodiments of base layer 550-10a may include a composite material containing fibers within a binding medium. Other suitable alternatives for the composition of first label 550 will be apparent to one skilled in the art in light of this disclosure. In certain embodiments, first label 550 may not include adhesive layer 550-10b, and in certain such embodiments a user may separately provide a means for adhering label 550 to bulkhead 510, such as, for example, adhesive tape; in some such cases label 550 may indirectly contact bulkhead 510, such as when double-sided tape, glue, and/or other mounting means are interposed between label 550 and gas seal bulkhead 510. In certain embodiments in which label 550 does not include adhesive layer 550-10b, label 550 may essentially consist of base layer 550-10a. When included, adhesive layer 550-10b advantageously is composed at least in part of a water-resistant adhesive; certain rubber-based and acrylic-based adhesives are examples of suitable options, and may in certain embodiments be used to provide label 550 with pressure sensitive adhesiveness for mounting to bulkhead 510. A structural adhesive may be used additionally or alternatively to mount label 550 to bulkhead 510. In certain embodiments, first gas seal 500 may be provided to a user with first label 550 already mounted to bulkhead 510; in certain other embodiments first gas seal 500 may be provided to a user with first label 550 unmounted to first gas seal bulkhead 510 and the user may mount first label 550 to first gas seal bulkhead 510, such as by manually mounting first label 550 to first gas seal bulkhead 510. In certain embodiments and/or methods of use, a user may operate a device, such as, for example, a tool and/or a machine configured to help mount first label 550 to first gas seal bulkhead 510. Certain embodiments of first label 550 may be substantially rigid rather than flexible.

FIGS. 76 and 77 respectively depict a perspective view and a side view of an embodiment of first gas seal 500 wherein first label 550-1 and second label 550-2 are provided for mounting to first gas seal bulkhead 510; as shown in FIGS. 76 and 77, first label 550-1 may be applied to first support column face 510-25 and second label 550-2 may be applied to second support column face 510-26, wherein first and second support column faces 510-25 and 510-26 are defined by first gas seal bulkhead 510. Alternatively, second label 550-2 may be applied to first label 550-1, such as when second label 550-2 is smaller than first label 550-1. Alternatively, both first label 550-1 and second label 550-2 may be applied directly to either first support column face 510-25 or second support column face 510-26.

In certain embodiments first label 550 may be applied to a surface other than or in addition to support column face 510-25 and/or support column face 510-26. Certain embodiments of gas seal bulkhead 510, such as the one shown in FIGS. 7, 9 and 10, may not include support column 510-20, first support column face 510-25, and/or second support column face 510-26. In certain embodiments that do define first support column face 510-25, first label 550 may be wider than first support column face 510-25 and may contact at least one additional portion of first gas seal bulkhead 510 when mounted to first support column face 510-25. Even in embodiments wherein first label 550 is not wider than first support column face 510-25, first label 550 may be mounted in such manner as to touch at least one portion of first gas seal bulkhead 510 other than first support column face 510-25. Certain embodiments of first label 550 may have a ring shape or other arc shape that facilitates mounting such embodiments within groove 510-30; in certain such embodiments it may be possible to mount first label 550 within groove 510-30 in such manner that label 550 does not touch either of first support column face 510-25 and second support column face 510-26.

FIG. 80 depicts a top view of an embodiment comprising first label 550 temporarily mounted on base sheet 5050-BSE. In certain embodiment versions, adhesive layer 550-10b of first label 550 may be placed in direct contact with base sheet 5050-BSE. In certain embodiment versions, base sheet 5050-BSE may include first adhesive side 5050-BSE-A, and base layer 550-10a of first label 550 may be placed in direct contact with first adhesive side 5050-BSE-A; in such embodiments the adhesive strength of first adhesive side 5050-BSE-A may advantageously be mild relative the adhesive strength of label adhesive layer 550-10b. Base sheet 5050-BSE may also be provided with optional alignment marking 5050-BSE-AM printed, impressed, perforated, and/or otherwise marked on base sheet 5050-BSE. A user may use alignment marking 5050-BSE-AM as a registration guide to align with a portion of first gas seal bulkhead 510, such as lateral flange 510-10; as shown in FIG. 80, first label 550 may be temporarily mounted on base sheet 5050-BSE in spaced relation to alignment marking 5050-BSE-AM such that when lateral flange 510-10 of first gas seal bulkhead 510 is aligned with alignment marking 5050-BSE-AM, first support column face 510-25 is aligned with first label 550. FIG. 81 depicts aligning first gas seal bulkhead 510 (dashed line contour) such that lateral flange 510-10 of first gas seal bulkhead 510 is aligned with alignment marking 5050-BSE-AM and first support column face 510-25 is aligned with first label 550. FIG. 82 depicts first support column face 510-25 in direct contact with first label 550.

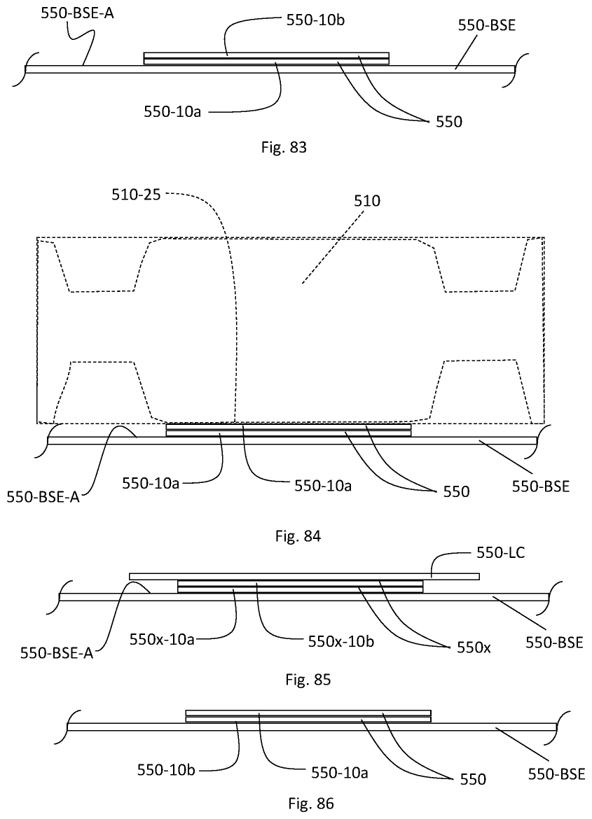

FIG. 83 is an enlarged view of first label 550 mounted temporarily on base sheet 5050-BSE with base sheet 5050-BSE shown broken at both ends due to the enlarged drawing scale and with base layer 550-10a of first label 550 shown in direct contact with first adhesive side 5050-BSE-A of base sheet 5050-BSE, with adhesive layer 550-10b of first label 550 being configured in exposed position in readiness for adhesively mounting to first gas seal bulkhead 510. FIG. 84 shows first support column face 510-25 of first gas seal bulkhead 510 pressed against adhesive layer 550-10b of first label 550 to activate the adhesive bond of layer 550-10b to first gas seal bulkhead 510 in order to securely mount first label 550 to first gas seal bulkhead 510; first label 550 may then be peeled away from base sheet 5050-BSE. In certain embodiments, pressure may not be needed to activate the adhesive bond of layer 550-10b to first gas seal bulkhead 510. FIG. 85 is an enlarged view of optional label cover 550-LC placed over adhesive layer 550x-10b in order to prevent premature adhesion to other objects before first label 550 is mounted to first gas seal bulkhead 510. Optional label cover 550-LC is also shown in FIGS. 80, 81, and 82 configured to cover second label 550x configured substantially concentrically within second alignment marking 5050-BSE-AMx. FIG. 86 depicts first label 550 configured such that adhesive layer 550-10b contacts and adheres to base sheet 5050-BSE; in such embodiments, base sheet 5050-BSE may not necessarily be provided with first adhesive side 5050-BSE-A, and layer 550-10a may be substantially nonadhesive, thereby preventing premature adhesion to other objects before mounting first label 550 to first gas seal bulkhead 510. When using the embodiment depicted in FIG. 86, a user may according to certain alternative methods of use manually peel first label 550 from base sheet 5050-BSE before mounting first label 550 to first gas seal bulkhead 510.

FIG. 80 also depicts third label 550y temporarily mounted on base sheet 550-BSE in spaced relation to third alignment marking 550-BSE-AMy; third alignment marking 550-BSE-AMy is exemplary of certain embodiment wherein alignment markings provided on base sheet 550-BSE are not substantially circular. According to a possible method of use, a user may position first gas seal bulkhead 510 such that lateral flange 510-10 is aligned substantially internally tangent to 4-sided alignment marking 550-BSE-AMy and thereby align third label 550y for transfer from base sheet 550-BSE to mounted position on first gas seal bulkhead 510. Fourth label 550z is shown temporarily mounted on base sheet 550-BSE in spaced relation to fourth alignment marking 550-BSE-AMz; fourth label 550z is exemplary of certain label embodiments which comprise multiple parts which may be temporarily mounted on base sheet 550-BSE in an initial spaced relation to one another and which may according to certain possible methods of use may be simultaneously transferred together to some mounted position on first gas seal bulkhead 510 that substantially preserves the initial spaced relation of the multiple label parts to one another. FIG. 80 depicts several alternative embodiments of first label 550 and alignment marking 550-BSE-AM in order to illustrate certain exemplary embodiments; in certain embodiments, first label 550 may be the only label temporarily mounted on base sheet 550-BSE; in certain embodiments, first label 550 and at least one additional label of the same type as first label 550 may be temporarily mounted together on base sheet 550-BSE. The number and type of label 550 embodiments and alignment marking embodiments provided on base sheet 550-BSE in FIG. 80 are exemplary and nonlimiting.

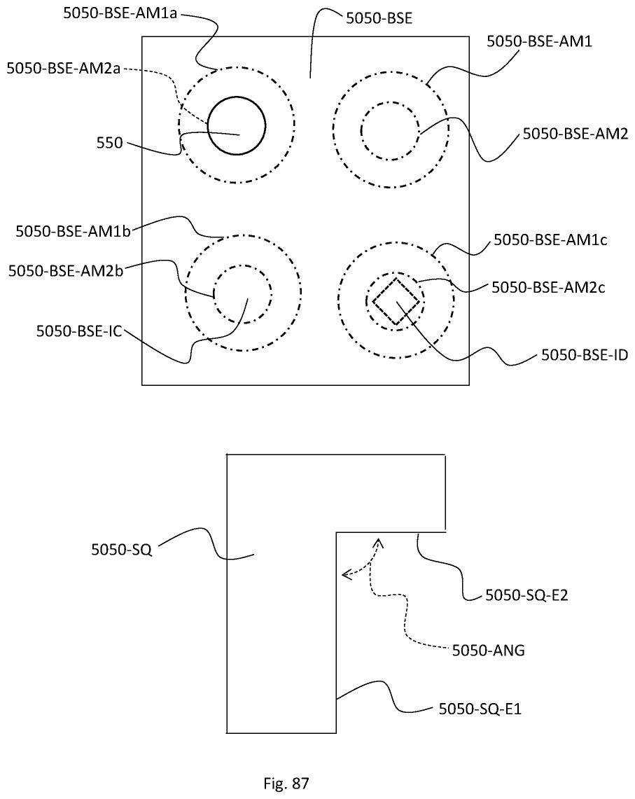

FIG. 87 depicts an embodiment comprising base sheet 5050-BSE and tangent tool 5050-SQ. Base sheet 5050-BSE is provided with outer alignment marking 5050-BSE-AM1 and may also be provided with inner alignment marking 5050-BSE-AM2 substantially concentric to first alignment marking 5050-BSE-AM1. A user may place first label 550 in registration with inner alignment marking 5050-BSE-AM2 and then use outer alignment marking 5050-BSE-AM1 to assist in registering lateral flange 510-10 of first gas seal bulkhead 510 when mounting first label 550 to first gas seal bulkhead 510; to allow an unobstructed view of outer alignment marking 5050-BSE-AM1 and inner alignment marking 5050-BSE-AM2, FIG. 86 shows first label 550 aligned with second inner alignment marking 5050-BSE-AM2a substantially concentric with second outer alignment marking 5050-BSE-AM1a. In certain embodiments, base sheet 5050-BSE may be provided with a region that is adhesive to a degree suitable for temporarily mounting first label 550 to base sheet 5050-BSE; some such embodiments may be adhesive over substantially an entire side of base sheet 5050-BSE, while on the other hand certain other embodiments may be adhesive over a more limited region; for example, FIG. 87 shows exemplary first adhesive region 5050-BSE-IC substantially covering the substantially circular region within third inner alignment marking 5050-BSE-AM2b and exemplary second adhesive region 5050-BSE-ID covering a substantially diamond-shaped region (indicated by dashed lines) within fourth inner alignment marking 5050-BSE-AM2c.

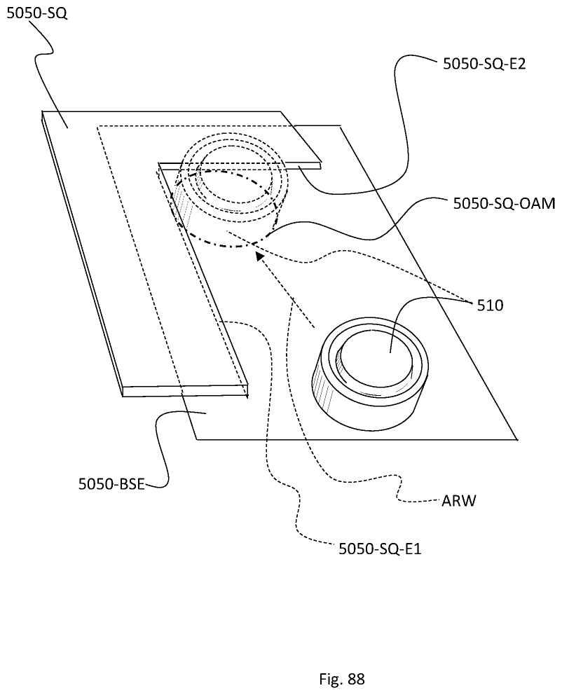

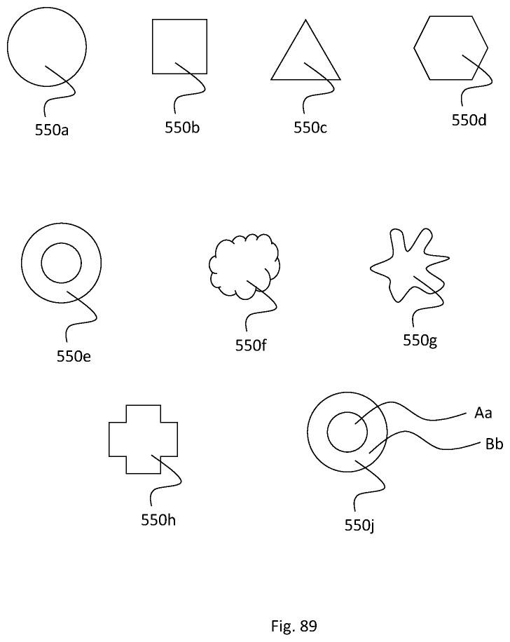

Certain embodiments which include at least one adhesive region such as 5050-BSE-ID may facilitate the user aligning first label 550 substantially concentric with an outer alignment marking such as 5050-BSE-AM1b without using an inner alignment marking such as third inner alignment marking 5050-BSE-AM2b, and therefore certain such embodiments may not include an inner alignment marking such as third inner alignment marking 5050-BSE-AM2b. FIG. 88 shows tangent tool 5050-SQ being used with an embodiment of base sheet 5050-BSE provided with outer alignment marking 5050-BSE-OAM and which may be provided with an adhesive region to temporarily mount first label 550 substantially concentric to outer alignment marking 550-BSE-OAM. Tangent tool 5050-SQ defines first edge 5050-SQ-E1 and second edge 5050-SQ-E2 defining angle 5050-ANG therebetween; as shown, tangent tool 5050-SQ may be aligned such that first edge 5050-SQ-E1 and second edge 5050-SQ-E2 are both substantially tangent to outer alignment marking 5050-BSE-OAM, and the user may then move first gas seal bulkhead 510 into contact against first edge 5050-SQ-E1 and second edge 5050-SQ-E2 to assist in registering first gas seal bulkhead 510 for mounting of first label 550 to first gas seal bulkhead 510. Arrow ARW in FIG. 88 indicates movement of first gas seal bulkhead 510 from an exemplary first position (solid line) to an exemplary second position (dashed line) in contact against first edge 5050-SQ-E1 and second edge 5050-SQ-E2 and in alignment with outer alignment marking 5050-BSE-OAM. In certain embodiments, base sheet 5050-BSE may include additional registration marks to facilitate aligning template tool 5050-SQ. In certain embodiments, template tool 5050-SQ may be coupled to base sheet 5050-BSE; in some such embodiments, outer alignment marking 5050-BSE-OAM may not be included, especially if an adhesive region such as 5050-BSE-ID is provide in spaced relation to first edge 5050-SQ-E1 and second edge 5050-SQ-E2 in order to facilitate registering first label 550 to the intended portion of first gas seal bulkhead 510 that first label 550 to be mounted to while lateral flange 510 is in substantially tangential contact with first edge 5050-SQ-E1 and second edge 5050-SQ-E2. Although FIG. 87 depicts the angle defined between first edge 5050-SQ-E1 and second edge 5050-SQ-E2 to be substantially a right angle, the angle defined by first edge 5050-SQ-E1 and second edge 5050-SQ-E2 may be other than a right angle.

FIG. 89 depicts some exemplary alternative embodiments of first label 550 to give a sample of the many possible variations on the shape of first label 550; FIG. 89 shows first label alternative embodiments 550a, 550b, 550c, 550d, 550e, 550f, 550g, and 550h, which are, respectively, round-shaped, 4-sided, triangular, hexagonal, donut-shaped, irregular-shaped, splat-shaped, and plus-shaped. FIG. 89 also shows first label alternative embodiment 550j, which is an exemplary multi-color embodiment having a first region Aa of a first color and a second region Bb of a second color distinct from the said first color of first region Aa.

In general, first label 550 may be used to help provide enhanced visibility of first gas seal 500. First gas seal bulkhead 510 may originally have a color which is not necessarily eye-catching and may not be easy to spot from a distance. Mounting first label 550 to first gas seal bulkhead 510 may provide enhanced visibility for first gas seal 500 and may make it easier to find first gas seal 500 after launch in order to use first gas seal 500 again. First label 550 may in certain embodiments be colored in at least one bright, intense hue; certain such embodiments may include at least one fluorescent dye. In certain embodiments, first label 550 may be colored for high contrast with first gas seal bulkhead 510, and may additionally or alternatively include regions within first label 550 that are colored distinctly from each other to cooperatingly create high visual contrast; for example, substantially complementary colors may be used. In certain embodiments, first label 550 may include one or more of features such as holographic patterns, prismatic elements, glitter, and phosphorescent surfaces. In certain embodiments, first label 550 may be provided with a surface configured to be marked by a marking instrument, such as a marker. Thus, certain embodiments exemplify that first label 550 may be mounted to first gas seal bulkhead 510 to help enhance the visibility of gas seal 500; in certain alternative embodiments and/or methods of use, first label 550 may modify the visual appearance of gas seal bulkhead 510 to make gas seal 500 less conspicuous.

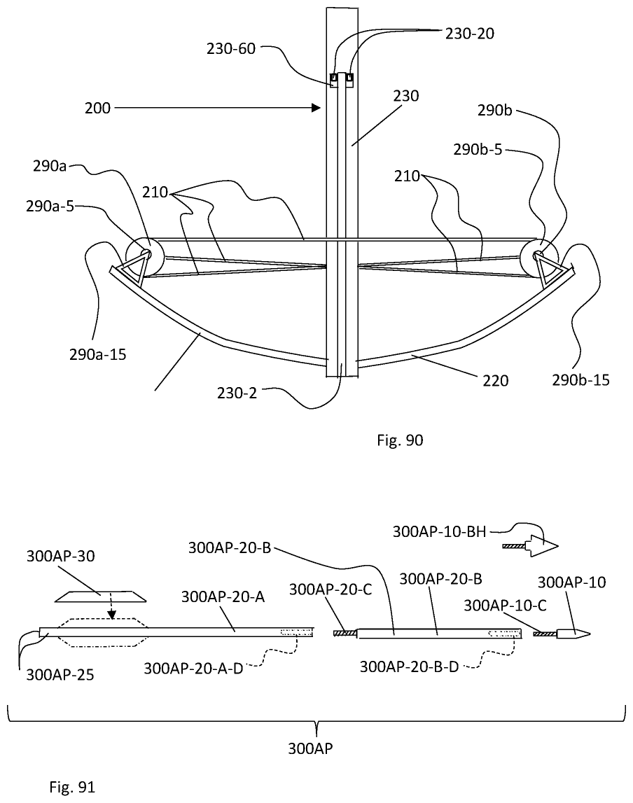

FIG. 90 depicts an exemplary alternative embodiment of pistol crossbow 200 comprising flexible yoke 210, deformable elastic thrust member 220 operationally coupled to flexible yoke 210, stock 230 operationally coupled to deformable elastic thrust member 220, and first pulley 290a operationally coupled to deformable elastic thrust member 220. In the exemplary embodiment shown in FIG. 90, flexible yoke 210 is operationally coupled to first pulley 290a and may in certain embodiment versions ride in at least one circumferential groove provided in pulley 290a. In the embodiment depicted in FIG. 90, pulley 290a is coupled to first axle 290a-5 coupled to first bracket 290a-15 coupled to deformable elastic thrust member 220. The embodiment shown in FIG. 90 may further comprise second pulley 290b, second axle 290b-5 coupled to second pulley 290b, and bracket 290b-15 coupled to second axle 290b-5, wherein deformable elastic thrust member 220 being coupled to second axle 290b-5. The exemplary embodiment shown in FIG. 90 thus has a compound bow configuration wherein yoke 210 coupled to first and second pulleys 290a and 290b and passing therearound may provide a mechanical advantage of the compound pulley configuration to assist a user in bending deformable elastic thrust member 220 for cocking pistol crossbow 200; in light of this disclosure it will be apparent to one having ordinary skill in the art that a variety of compound bow pulley and cable configurations may be employed. Certain alternate embodiments may have a split limb and/or multi-limb configuration wherein deformable elastic thrust member 220 defines a gap for coupling first pulley 290a; certain such embodiments may not be provided with first bracket 290a-15. Certain embodiments may comprise a deformable elastic thrust member 220 configured to bend in a forward direction when coupled to yoke 210 and thereby provide a reverse draw feature. It will be apparent to one skilled in the art that, in certain embodiments, pistol crossbow 200 may be provided with alternate embodiments and configurations of deformable elastic thrust member 220 without departing from the spirit and scope of the inventive disclosure and claims; likewise, certain embodiments of pistol crossbow 200 may be provided with alternate embodiments and configurations of elements such as, for example, yoke 210, stock 230, and trigger 240, while still remaining within the scope of the inventive disclosure and claims.

FIG. 91 depicts an alternate embodiment arrow projectile 300AP having shaft 300AP-20 comprising first shaft segment 300AP-20-A; certain versions of shaft 300AP-20 may further comprise second shaft segment 300AP-20-B, wherein second shaft segment 300AP-20-B being provided with coupling extension 300AP-20-B-C provided with external threads configured to mate with internal threads provided in first shaft segment aperture 300AP-20-A-D, and wherein second shaft segment 300AP-20-B being provided with internally threaded second shaft segment aperture 300AP-20-B-D. Optional first head 300AP-10 is provided with head coupling extension 300AP-10-C provided with external threads configured to selectively mate with internally threaded first shaft segment aperture 300AP-20-A-D and to also selectively mate with, when provided, internally threaded second shaft segment aperture 300AP-20-B-D. Certain embodiments may alternatively or additionally include optional first broadhead 300-AP-10-BH. In certain embodiments, first shaft segment 300AP-20-A coupled to first head 300AP-10 may provide a pistol crossbow bolt having length and/or mass within at least one of the mass and length ranges that may apply to certain one or more embodiments disclosed herein, whereas first shaft segment 300AP-20-A coupled to second shaft segment 300AP-20-B coupled to first head 300AP-10 may provide an arrow projectile exceeding at least one of the mass and length ranges that may apply to certain one or more embodiments disclosed herein, and in certain such embodiments may provide an oversize bolt projectile having a mass exceeding 235 grains and in certain embodiments not exceeding 300 grains. First vane 300AP-30 may optionally be provided uncoupled to shaft 300AP-20, as shown in solid line, and for mounting to shaft 300AP-20 in position such as exemplary coupled position (dashed line pointed to by dashed arrow; another exemplary coupled position is shown by alternating dash-dot line); at least one of an adhesive, binding, whipping, and other suitable means may be used to assist in coupling first vane 300AP-30 securely to shaft 300AP-20.

FIGS. 92-95 depict an alternative embodiment wherein first gas seal 500 being tethered to blowgun launch tube 410, as in FIG. 92, by tether 900 provided with elongate, flexible tether cord 910;

FIG. 93 depicts first gas seal 500 and tether 900 in relation to implied embodiment variant hollow acceleration tube 410-HAT, and FIG. 94 depicts an embodiment in which hollow acceleration tube 410-HAT being provided with port 410-HAT-60. Tether 900 may be coupled with hollow acceleration tube 410-HAT by, for example, insertion of tether cord 910 into aperture 410-HAT-20; other methods of coupling tether 900 to hollow acceleration tube 410-HAT and/or to blowgun launch tube 410 will be apparent to those having skill in the art in light of this disclosure. FIGS. 92 and 93 shows tether cord 910 in folded configuration prior to acceleration. FIG. 94 shows first gas seal 500 halted at the end of acceleration stroke INT as tether cord 910 reaches full extension permitted by the length of tether cord 910; acceleration stroke INT may be of different length than that depicted in FIG. 94. FIG. 94 shows first pistol crossbow bolt 300 provided with shaft 300-20 and first vane 300-30 continuing forward after being accelerated by first gas seal 500; as shown, first pistol crossbow bolt may initially be oriented at somewhat of an angle to the direction of flight. FIG. 95 shows an alternative embodiment of first gas seal 500 in which first gas seal 500 is further provided with eyebolt 590 defining eye 590-10 configured for insertion therethrough of tether 900 for coupling by method such as by tying a knot; eyebolt 590 may further define elongate shank 590-20 configured for insertion into gas seal support column 510-20, and may be provided with threads to enhance coupling with gas seal 500. FIGS. 93 and 94 show tether 900 coupled to gas seal 500 by inserting tether 900 directly through support column 500-20 and tying a knot; a curved needle and/or other methods may be used to facilitate such insertion, and alternative methods of coupling gas seal 500 with tether 900 will apparent to those skilled in the art in light of this disclosure. Monofilament, braided, and parallel fiber lines such as are used to provide fishing lines and bowstrings are contemplated for use to provide tether cord 910. In certain embodiments, tether cord 910 may be configured, such as by being selectively creased, compressed, and the like, in such manner to dispose tether 910 to tend to coil and/or fold compactly when unextended. It is contemplated that tether cord 910 may be composed at least in part of one or more synthetic polymers such as, for example, polyamides, polypropylene, polyvinyl chloride, and polyethylene, including polyethylene terephthalate and ultra high molecular weight polyethylene.

The present disclosure contemplates certain inventive embodiments comprising a pistol crossbow compatibly configured to be capable of elastically launching a first pistol crossbow bolt without undue risk of dry fire damage to the pistol crossbow caused by excessive acceleration of the deformable elastic thrust member, provided that the first pistol crossbow bolt is securely engaged with the flexible yoke of the pistol crossbow during launch. The present disclosure also contemplates certain embodiments comprising a pistol crossbow cooperably configured to launch a first pistol crossbow bolt, yet not necessarily compatibly configured to be capable of launching the said first pistol crossbow bolt without undue risk of dry fire damage; for example, a pistol crossbow embodiment intended for flight shooting competition, in which projectiles are launched for maximum range, may be optimized for velocity at the expense of longevity, and in certain such embodiments it may even be necessary to replace at least one component, such as the flexible yoke, after each launch. Even if a pistol crossbow embodiment is compatibly configured to launch a first pistol crossbow bolt without undue risk of dry fire damage, factors such as normal wear and tear, lapses in maintenance, improper use, and improper handling may contribute to possible damage and even structural failure of such a pistol crossbow.

It may be noted that certain manufacturing techniques, such as, for example, certain 3D-printing processes, make it possible to create detailed miniature objects having mass as low as approximately 0.1 grain and length as short as 0.1 inch; in fact, certain 3D-printing processes allow printing of objects having even lower mass than 0.1 grain and/or shorter length than 0.1 inch, and some such 3D-printed objects are actually microscopic and not visible to the unaided naked eye. The instant inventive disclosure contemplates certain method variants and embodiments wherein including a first pistol crossbow bolt having a mass in the range from 0.1 grain to 190 grains, inclusive, and a longitudinal length in the range from 0.1 inch to 36 inches, inclusive. A pistol crossbow provided with at least one rubber deformable elastic thrust member may be well-suited for elastically launching a pistol crossbow bolt having an exemplary length of 36 inches. It will be apparent to one having ordinary skill in the art that, in light of this disclosure, certain limits on the length and/or mass of a first pistol crossbow bolt may be imposed by practical considerations such as, for example, material properties, manufacturing processes, and functionality. As was noted earlier, certain commercially manufactured pistol crossbow bolts typically have lengths in the range from about 4 inches to about 10 inches and masses in the range from about 50 grains to about 180 grains. Certain embodiments and method variants contemplated by the instant inventive disclosure may place other, sometimes narrower restrictions on at least one of the length and mass of a first pistol crossbow bolt; for example a first pistol crossbow bolt having a mass in the range from 50 grains to 115 grains, inclusive, and a longitudinal length in the range 4 inches to 8 inches, inclusive, may provide a balance of velocity and energy performance that may characterize for certain users an exemplary general-purpose pistol crossbow bolt. On the other hand, certain embodiments and method variants contemplated by the instant inventive disclosure may have masses and lengths that fall outside at least one of the typical mass and length ranges described above; for example, a 10 grain, 2 inch pistol crossbow bolt may perform efficiently with a pistol crossbow having a relatively low draw weight, and also be accelerated to relatively high velocities by breath; a further example is a 12 inch, 235 grain pistol crossbow bolt intended for hunting, which may achieve lower velocity for a given amount of thrust than the exemplary 10 grain, 2 inch pistol crossbow bolt, yet have higher energy and momentum to deliver to the target. The instant inventive disclosure also contemplates certain embodiments and method variants wherein including a first pistol crossbow bolt having a positive-valued length less than 0.1 inch and/or a positive-valued mass less than 0.1 grain; certain such first pistol crossbow bolt embodiments may actually be microscopic, and it is within the ability of those skilled in the art to determine the lower limits of possible size, which may change over time as miniature manufacturing techniques continue to develop. Certain embodiments of a miniature pistol crossbow of cooperable, possibly microscopic, scale may be formed monolithically, wherein the stock, elastically deformable thrust member, and flexible yoke are defined by a monolithic body. It is within the ability of those skilled in the art to determine the lower limit of inner diameter of a cooperably scaled blowgun in order that the hollow launch tube may be pressurized by breath.

The instant inventive disclosure contemplates certain method variants and embodiments wherein including a first pistol crossbow bolt having a mass in the range from 1 grain to 235 grains, inclusive. Certain embodiments may comprise a first pistol crossbow bolt having a mass in the range from 1 grain to 235 grains, inclusive, and a longitudinal length in the range from 0.5 inch to 18 inches, inclusive; however, certain first pistol crossbow bolts having a mass within the range from 1 grain to 235 grains may have a length that exceeds 18 inches; for example, a 30 inch carbon fiber shaft having a mass of 5 grains per inch coupled with a 50 grain metal head and with an 8 grain first vane would provide a first pistol crossbow bolt having a combined mass of 208 grains. A bolt retention clip and a forward extension of the stock are examples of pistol crossbow features that may be configured to provide additional stabilization, if needed, to a first pistol crossbow bolt having sufficient length to tend to tip away from contact with the stock under the influence of gravity and/or launch forces without such additional stabilization. The instant inventive disclosure contemplates certain method variants and embodiments wherein including a first pistol crossbow bolt having a mass in the range from 0.1 grain to 190 grains, inclusive, and a longitudinal length in the range from 0.1 inch to 36 inches, inclusive.

As noted earlier, elastic archery projectors, such as pistol crossbows, are generally able to safely launch archery arrow projectiles substantially more massive than the projectors' respective minimum projectile mass recommendations. The instant inventive disclosure contemplates certain alternative embodiments and method variants including a first oversize bolt projectile, wherein said first oversize bolt projectile having a mass within the range from 236 grains to 300 grains, inclusive, and a length within the range from 3 inches to 15 inches, inclusive; such relatively heavy masses may exhibit relatively low velocities and relatively limited effective ranges when launched by breath, but may be useful for certain applications such as fishing in which shooting is typically done at fairly short ranges to the target. Certain embodiments of a first oversize bolt projectile intended for use in fishing may comprise a metal head coupled to a shaft, wherein said metal head being provided with a first barb, and certain such embodiments may optionally further comprise a first vane; the length of any optional fishing line coupled to the first oversize bolt projectile is not here considered to be included in the length of the first oversize bolt projectile. Certain first pistol crossbow bolt embodiments may also be useful for fishing applications. Certain embodiments and method variants contemplated by the instant inventive disclosure may include a first pistol crossbow bolt that, as initially provided, comprises a shaft and a first vane configured to be capable of being coupled to said shaft; wherein a user may independently provide a head cooperably configured to be capable of being coupled to said shaft. The instant inventive disclosure contemplates certain embodiments that may alternatively or additionally comprise a deformable elastic thrust member other than or in addition to a bowed spring; for example, the deformable elastic thrust member may in certain embodiments comprise at least one elastic rubber element, wherein elastic rubber may include, but is not limited to, at least one elastic polymer, such as a latex elastomer. Even if a first pistol crossbow is compatibly configured to be capable of launching a first pistol crossbow bolt without undue risk of dry fire damage, a second pistol crossbow bolt having the same length and mass as the first pistol crossbow bolt may possibly not be cooperably configured to be capable of being elastically launched by the said first pistol crossbow; for example, a first pistol crossbow being cooperably configured to be capable of launching a particular 5 inch, 85 grain first pistol crossbow bolt, and further being provided with an anti-dry fire safety, would not operate if loaded with a 5 inch, 85 grain second pistol crossbow bolt wherein the second pistol crossbow bolt being in some way incorrectly dimensioned, such as by having a shaft of the wrong diameter, to deactivate the said anti-dry fire safety; however, in such a case, certain method variants and embodiments may involve a tool configured to deactivate the said anti-dry fire safety and permit use of the said first pistol crossbow to elastically launch the said second pistol crossbow bolt; alternatively, the said anti-dry fire safety may in certain embodiments be configured to be adjustable for use with multiple shaft diameters. Thus it may be seen that the inventive disclosure contemplates certain embodiments wherein the pistol crossbow as provided is not initially cooperably configured to elastically launch the operatively associated first pistol crossbow bolt. It may also be seen that the inventive disclosure contemplates certain embodiments wherein the first pistol crossbow bolt as provided is cooperably configured to be elastically launched by the operatively associated pistol crossbow; and it may be seen, furthermore, that the inventive disclosure contemplates certain embodiments wherein the first pistol crossbow bolt as provided is compatibly configured to be elastically launched by the operatively associated first pistol crossbow.

The instant inventive disclosure also contemplates a system comprising a vertical bow provided with a flexible yoke coupled to a bowed spring, a blowgun provided with a hollow launch tube, a first gas seal configured to slidably interiorly partition the hollow launch tube of the blowgun, and a first pistol crossbow bolt provided with a first vane coupled to a shaft coupled to a metal head, wherein the first pistol crossbow bolt is configured to be selectively launched by the vertical bow and the blowgun, wherein the first pistol crossbow bolt defining a proximal bolt end configured to selectively engage the flexible yoke and the gas seal, and wherein the vertical bow defining a handle configured to be gripped by a user, the vertical bow being compatibly and cooperably configured to be capable of elastically launching the first pistol crossbow bolt without undue risk of dry fire damage. Certain embodiments may comprise a full-scale vertical bow configured and/or tuned to be compatibly configured to launch the first pistol crossbow bolt without undue risk of dry fire damage; certain embodiments may comprise a miniature vertical bow. Certain embodiments and/or methods of use may involve drawing a full-scale vertical bow to only a fraction of its set draw length in order to store energy for launching the first pistol crossbow bolt, wherein in certain such embodiments and/or methods of use, drawing the full-scale vertical bow to its full set draw length would cause undue risk of dry fire damage when launching the first pistol crossbow bolt. The instant inventive disclosure also contemplates certain methods that involve drawing a full-scale crossbow to only a fraction of its set draw length in order to store energy for launching a first pistol crossbow bolt, wherein drawing the full-scale crossbow to its full set draw length would cause undue risk of dry fire damage when launching the first pistol crossbow bolt. In certain embodiments the bowed spring may comprise a first bow limb, and the vertical bow may further include a riser coupled to the said first bow limb. In certain embodiments, the vertical bow may have a power stroke length in the range from 0.5 inch to 27 inches, inclusive, and in certain embodiments, the vertical bow may be provided with an overdraw rest configured to operatively touch said first pistol crossbow bolt at some first point disposed in rearwardly spaced relation to the handle of the vertical bow, thereby supporting and guiding the first pistol crossbow bolt, and in certain embodiments permitting use of a first pistol crossbow bolt having a longitudinal length shorter than the draw length of the vertical bow; thus, certain embodiments comprise a first pistol crossbow bolt having a longitudinal length shorter than the draw length of the vertical bow. In certain such embodiments, such an overdraw rest may have a first portion slidably coupled to the handle and/or riser of the vertical bow; in certain such embodiments, such an overdraw rest may additionally or alternatively have a first portion substantially nonmovably affixed to the handle and/or riser of the vertical bow.

It may be seen in view of this disclosure that within the scope and the spirit of the inventive disclosure and the claims appended hereunto is an inventive system comprising a pistol crossbow, a blowgun, a first gas seal operatively associated with said blowgun, and a first pistol crossbow bolt selectively operatively associated with said pistol crossbow and said blowgun, said first pistol crossbow bolt configured to be capable of being selectively operatively interchanged between said pistol crossbow and said blowgun for elastic launching by said pistol crossbow and pneumatic launching by said blowgun. It may further be seen in view of this disclosure that within the scope and the spirit of the inventive disclosure and the claims appended hereunto are inventive system and method examples including, but not limited to, a method of driving a hardware fastener and/or providing a hardware fastener driving system, a system and method for a PPECS stabilizer acceleration interface, and a gas seal comprising a bulkhead and a label configured to be capable of being mounted to said bulkhead. Descriptions of specific embodiments in drawings and written passages within the specification are illustrative and exemplary, and do not limit general embodiments according to the spirit of the claims.

I claim:

1. In combination:
A first pistol crossbow bolt comprising a metal head, a shaft operationally coupled to said metal head, said shaft defining a maximum shaft width, and a first vane operationally coupled to said shaft in laterally extending alignment with respect to said shaft, said first vane defining a trailing edge and a lateral edge, said first pistol crossbow bolt terminating proximally in a proximal bolt end, said first pistol crossbow bolt having a mass in the range 1 grain to 235 grains inclusive; and
A first gas seal selectively operatively associated with said first pistol crossbow bolt, said first gas seal comprising a bulkhead defining a maximum bulkhead width greater than said maximum shaft width, said first gas seal configured to operatively engage said proximal bolt end;
Wherein said first pistol crossbow bolt being configured to be capable of being elastically launched by a cooperably configured pistol crossbow;
Wherein said bulkhead being configured to be capable of slidably interiorly substantially partitioning a reciprocally dimensioned hollow launch tube of a blowgun during breath-driven acceleration therewithin.

2. The apparatus of claim 1 wherein said first pistol crossbow bolt having a mass in the range from 5 grains to 160 grains, inclusive, and a longitudinal length in the range from 0.5 inch to 16 inches, inclusive.

3. The apparatus of claim 1 wherein said first pistol crossbow bolt defining a maximum transverse width in the range from about 0.3 inch to about 0.7 inch.

4. The apparatus of claim 1 wherein said bulkhead comprises a monolithic plastic resin body designed to be suitable for use as a nonintegral overpowder obturator in a shotgun shotshell fueled by dry chemical propellant.

5. The apparatus of claim 1 further including a pistol crossbow cooperably configured to be capable of elastically launching said first pistol crossbow bolt, said pistol crossbow comprising a flexible yoke configured to operatively engage said proximal bolt end, a deformable elastic thrust member operationally coupled to said yoke, and a stock operationally coupled to said deformable elastic thrust member.

6. The apparatus of claim 5 further including a hollow launch tube configured to be pressurized by breath, said hollow launch tube being reciprocally dimensioned to be capable of being slidably interiorly substantially partitioned by said bulkhead when said hollow launch tube is pressurized by breath.

7. The apparatus of claim 1 wherein said first pistol crossbow bolt comprises a monolithic member defining said shaft and said first vane.

8. The apparatus of claim 1 further comprising a processing tool operatively configured to assist in reconfiguring said first vane from a first size-shape state to a second size-shape state.

9. The apparatus of claim 8 wherein said processing tool is configured to define a first abrasive surface suitable for operationally assisting in removing material from said first vane.

10. The apparatus of claim 1 wherein said first gas seal includes a lateral flange and a medial support column defining a forwardly opening annular groove therebetween.

11. The apparatus of claim 1 wherein said first gas seal defines a receptacle reciprocally dimensioned to receivingly engage said proximal bolt end and thereby frictionally attach said first gas seal to said first pistol crossbow bolt.

12. The apparatus of claim 1 further including a hollow launch tube configured to be pressurized by breath, said hollow launch tube being reciprocally dimensioned to be capable of being slidably interiorly substantially partitioned by said bulkhead when said hollow launch tube is pressurized by breath.

13. The apparatus of claim 7 further comprising a target configured to be suitable for releasably capturing said first pistol crossbow bolt when said first pistol crossbow bolt is selectively launched by said pistol crossbow and said hollow launch tube.

14. In combination:
A first gas seal bulkhead comprising a monolithic plastic resin body designed to be suitable for use as a nonintegral overpowder obturator in a shotgun shotshell fueled by dry chemical propellant, and A first label configured to be mountable to said first gas seal bulkhead.

15. The apparatus of claim 14 wherein said first label is mounted to said first gas seal bulkhead.

16. The apparatus of claim 14 wherein said first label comprises a base layer and an adhesive layer, said adhesive layer comprising a pressure-sensitive adhesive coating applied to said base layer, said base layer configured to exhibit visual contrast with said first gas seal bulkhead.

17. A method of driving a hardware fastener, comprising:
a) Providing a first hardware fastener comprising a monolithic metal body defining an elongate shaft and a driving head;
b) Providing a first gas seal comprising a bulkhead, said bulkhead comprising a plastic resin body designed to be suitable for use as a nonintegral overpowder obturator in a shotgun shotshell fueled by dry chemical propellant;
c) Providing a hollow acceleration tube reciprocally dimensioned for breath-driven acceleration of said first gas seal and said first hardware fastener therewithin;
Wherein steps a, b, and c are in no particular order with respect to one another.

18. The method of claim 17, further comprising:
d) Pressurizing said hollow acceleration tube with breath to accelerate said first gas seal and said first hardware fastener therewithin toward a construction workpiece, wherein said first hardware fastener impacting said workpiece and at least partially driving into said workpiece, Wherein step d occurs later than steps a, b, and c.

19. The method of claim 18, wherein step d further including touching said construction workpiece with a stabilizer leg coupled to said hollow acceleration tube, wherein said stabilizer leg assisting to stabilize said hollow acceleration tube in spaced relation to said workpiece during acceleration of said first gas seal and said first hardware fastener.

20. The method of claim 18, further comprising:
e) using at least one driver tool to continue driving said first hardware fastener farther into said construction workpiece, wherein step e occurs later than step d.
